(19) United States
(12) Patent Application Publication
(10) Pub. No.: US 2017/0081879 A1
(43) Pub. Date: Mar. 23, 2017

(54) BLANK KEY, A LOCK SET WITH A SECURITY MECHANISM AND METHOD FOR PRODUCING SAME

(71) Applicant: Raphael Moshe INBAR, EILAT (IL)

(72) Inventor: Eyal ARTSIELY, Moshav Yafit (IL)

(21) Appl. No.: 14/960,448

(22) Filed: Dec. 7, 2015

Related U.S. Application Data
(63) Continuation-in-part of application No. 14/859,388, filed on Sep. 21, 2015.

(51) Int. Cl. E05B 21/06; E05B 35/00; E05B 29/00; E05B 19/00

(52) U.S. Cl. CPC E05B 21/063; E05B 19/0023; E05B 35/006; E05B 29/0033

(57) ABSTRACT

The present invention provides a key blank and a key set. The key blank includes one or more telescopic members inserted through corresponding one or more channels of the key shank for fitting to release a security mechanism of a lock unit. The lock set has one or more fitting keys and a lock unit including: a stator; a rotor; a first locking mechanism; and an additional security mechanism including one or more wafer units. The key shank has one or more telescopic members each inserted in a channel perforated in the key shank. The wafer unit of the security mechanism is located and configured for engaging an edge of the telescopic member when the fitting key is used, such that each telescopic member will move the respective wafer unit it engages for releasing the additional security mechanism for allowing the rotor to rotate in the stator.

### CROSS-REFERENCE TO RELATED PATENT APPLICATIONS

This application is a Continuation in Part of U.S. patent application Ser. No. 14/859,388 filed on Sep. 21, 2015.

### FIELD OF THE INVENTION

The present invention generally relates to keys, locking devices, apparatuses, sets and mechanisms and more particularly to key blanks, keys and lock sets and methods for producing thereof.

### BACKGROUND OF THE INVENTION

Cylinder locks typically include a stator configured for being installed in the system it is to secure such as a door or a car starter system and the like, and a rotor member having a key slot therein for receiving a key fitted to the particular cylinder lock for locking and unlocking thereof.

The rotor component of the cylinder lock in many designs has one or more pins moveable by springs that are adapted to fit key cuts indented over one or more surfaces of the key for pressing them towards the inner wall of the stator for enabling the rotation of the rotor inside the stator usually for moving one or more cam tenons thereof for releasing or projecting an engaging member of the lock set for locking or unlocking e.g. a door.

Patent application no. EP2108767 to Alban teaches a cylinder lock comprising: a stator, a cylindrical rotor for the actuation of the bolt, which is accommodated rotatably within the stator and in which a slot for the opening of a key for the operation of the lock is formed, coding pins and driver pins for blocking the rotation of the rotor within the stator, which can slide within radial holes provided correspondingly within the rotor and within the stator, elastic means for pushing the coding pins against an internal wall of the slot, which faces the holes, the elastic means being further adapted to align the coding pins and the driver pins to allow the rotation of the rotor within the stator when one key having a predefined profile for opening the lock is inserted in the slot; at least one pusher, which is accommodated in at least one first hole of the holes and defines a safety position for at least one first pin of the coding pins in which the first coding pin is spaced from the wall even when no key is inserted in the slot.

U.S. Pat. No. 5,520,035 to Eizen et al. teaches a key blank including a generally elongate shaft portion defining a key combination surface adapted to have formed thereon key cuts which define a key combination, the key blank including a movable pin element retained within the elongate shaft portion, the movable pin element being displaceable in a single direction, outwardly from the key combination surface.

Patent application No. IL191855 (also published as WO2009147660A2) to Haviv, teaches a key blank comprising a shaft and a head connected to the shaft, the shaft including first and second surface that are oppositely facing, wherein the surfaces are configured to include combination elements to operate a lock and a pair of coaxial operating elements, wherein one element of the pair is operative from the first surface of the shaft and the other element of the pair is operative from the second surface of the shaft, and wherein at least one of the operative elements is a resilient element mounted inside a bore provided in the shaft, wherein the resilient element is operative to exert a compressive force on a pin mechanism of the lock in response to the operative engagement and thereby release the pin mechanism from a lock position, without requiring any pressure on the coaxial element on the other side.

Patent application No. FR 2492872 teaches a key for a barrel lock comprising a handle extending from the key body inserted into the rotor contained inside the barrel. The external surface of the key body contains at least one captive ball-bearing retained inside a recess by a strip. On insertion into the lock, a correspondingly placed pin on the rotor acts on the ball-bearing through a hole in the strip. The ball-bearing is consequently displaced and projects from the other side of the recess allowing a piston to be moved and the key to be rotated.

GB2161204 teaches a pair of aligned moving bodies that are formed in opposite edges of the shank of the key. Each moving body comprises an operating part 8 and a rear part 11 which is located in a blind hole. A spring acts on the moving body so as to cause the head of the operating part to protrude beyond the shank, the moving body being retained in the hole by an annular rim The key is used with a lock which is provided with additional locking pins which are engaged by the moving bodies and driven thereby into an unlocking position. In an alternative arrangement, a pair of moving bodies are provided in the straight edge of the shank of a key, the other edge of which is provided with teeth.

### SUMMARY OF THE INVENTION

The present invention provides a key blank comprising: a key shank having at least one channel perforated over at least one side thereof, the key shank being configured for connecting at one first end thereof to a key head; and at least one telescopic member each inserted in each of said at least one channel in said key shank, each of said at least one telescopic member comprising at least one resilient element and two cap elements each cap element being located at an edge of said telescopic member, wherein the telescopic member is configured such that it is changeable in length in response to a force applied thereover and returnable to a predefined relaxation state length, wherein the at least one telescopic member is located and configured such as to engage at least one corresponding wafer of a wafer tumbler lock unit for moving the corresponding wafer to allow rotation of a rotor inside a stator of the respective wafer tumbler lock unit.

According to some embodiments, the at least one resilient element is a spring such as a coiled spring.

According to some embodiments, each telescopic member and channel thereof is located proximally to the first end of the key shank and before an area over the key shank that is to be indented for specifying of the blank key, wherein each channel is located such that at least one of the cap elements of the telescopic member located therein is protrudable from at least one side of the key shank that is perpendicular to the at least one side of the key shank that is to be indented.

The present invention further provides a key blank comprising: a key shank having at least one channel perforated over at least one side thereof, the key shank being configured for connecting at a first end thereof to a key head;

and at least one telescopic member each inserted in each of the at least one channel in the key shank, each of the at least one telescopic member comprising at least one resilient element and two cap elements each cap element being located at an edge of the telescopic member, wherein the telescopic member is configured such that it is changeable in length in response to a force applied thereover and returnable to a predefined relaxation state length, wherein each of the at least one telescopic member and channel thereof is located over the key shank proximally to the first end thereof and before an area over the key shank that is to be indented for specifying of the blank key, and wherein each channel is located such that at least one of the cap elements of the telescopic member located therein is protrudable from at least one side of the key shank that is perpendicular to the at least one side of the key shank that is to be indented.

According to some embodiments, the at least one resilient element is a spring.

According to some embodiments, the at least one telescopic member is located and configured such as to engage at least one corresponding wafer of a wafer tumbler lock unit.

The present invention additionally provides a lock set comprising: (a) a cylinder lock comprising: a stator; a rotor configured for being coaxially situated in the stator for rotating therein, the rotor having at least one key slot for receiving a key therein and at least one wafer opening; a moveable element operatively associated with the rotor such that once the rotor is rotated in the stator it moves the moveable element for operating the lock unit; a first locking mechanism; and an additional security mechanism comprising at least one wafer unit inserted through at least one of the at least one wafer opening in the rotor; and (b) at least one fitting key having a key shank with at least one combination indented or etched over at least one side thereof and at least one telescopic member each inserted in a channel perforated in the key shank of the fitting key, the telescopic member being configured such that it can change at least in length in response to a force applied thereover and return to a predefined relaxation state length, wherein the wafer unit of the additional security mechanism is located and configured for engaging at least one edge of the telescopic member of the fitting key when inserted through the key slot such that each of the at least one telescopic member will move the respective wafer unit it engages such that the fitting key will enable to release the additional security mechanism and the first locking mechanism for positioning the rotor in a released rotor position, in which the rotor is freely rotatable in the stator.

According to some embodiments, the lock unit is a wafer tumbler lock unit and the first locking mechanism comprises at least one other wafer unit configured to fit the indentation combination of the fitting key, each other wafer unit being inserted through a wafer opening in said rotor.

The wafer tumbler lock unit may further comprise a base structure holding all wafer units of the first locking mechanism and the additional security mechanism partially also configured to engage the fitting key indentation combination.

According to some embodiments, each wafer unit comprises a wafer element and at least one resilient element.

According to some embodiments, the at least one telescopic member comprises a resilient element and two cap elements each cap element being connected to a different edge of said resilient element.

According to some embodiments, the resilient element of each telescopic member exerts a force that is greater than the force exerted by the resilient element of the second wafer unit such as to force the wafer element thereof to move for releasing the rotor, when the fitting key is inserted in the lock unit.

According to some embodiments, the resilient element of the telescopic member is a coiled spring.

According to some embodiments, the at least one telescopic member of the fitting key and channel in which it is located are located proximally to the key head and before the area over the shank of the fitting key that indented.

According to some embodiments, the telescopic member protrudes in a relaxed state thereof at least from one side of the key shank from a respective opening of the channel in which it is located, the protrusion opening from which it protrudes is perpendicular to the at least one side of the key shank over which the combination is indented.

### BRIEF DESCRIPTION OF THE DRAWINGS

FIG. 1 shows an exploded view of a lock set having a security mechanism, according to some embodiments of the present invention.

FIG. 2 shows a key fitting to the lock set of FIG. 1, according to some embodiments of the present invention.

FIG. 3 shows a cross sectional view of a rotatable member of a cylinder lock of the lock set shown in FIG. 1.

FIG. 4 shows a frontal view of a stator of the lock set as described in FIG. 1 showing a groove slotted over an inner side thereof that corresponds in size, shape and location a side slot of the rotatable member for having the security element of the lock set protrude into this groove for preventing rotation of the rotatable member in the stator, according to some embodiments of the invention.

FIG. 5 shows an exploded view of a lock set with a security mechanism of a different size than that illustrated in FIG. 1, according to some embodiments of the present invention.

FIGS. 6A-6C show cross sectional views of three different lock sets having security elements of a specific first type having the same overall length, according to some embodiments of the present invention, differentiated from one another by the lengths of one or two protrusions of their security element requiring different key recess and/or forming different operating positions of the telescopic member: FIG. 6A shows a lock set having a security element in which the first protrusion is longer than the second protrusion; FIG. 6B shows a lock set having a security element in which the first protrusion is longer than the second protrusion; and FIG. 6C shows a lock set having a security element having protrusions of the same length.

FIGS. 7A-7C show cross sectional views of three different lock sets having a security element of a specific second type having the same overall length, which is shorter than the length of the first type security elements, according to some embodiments of the present invention differentiated from one another by the length of protrusions of their security elements requiring different key recess and/or telescopic member sizes: FIG. 7A shows a lock set having a security element in which the first protrusion is longer than the second protrusion; FIG. 7B shows a lock set having a security element in which the first protrusion is longer than the second protrusion; and FIG. 7C shows a lock set having a security element having protrusions of the same length.

FIGS. 8A, 8B and 8C show different security elements of the first type having the same overall height and varied protrusions lengths and varied inner indentations sizes and/or locations.

FIGS. 9A, 9B and 9C show different security elements of the second type having the same overall height, which is shorter than that of the first type.

FIGS. 10A-10C show how different keys being inserted into the same cylinder lock, wherein only one of the keys fits the specific lock by having fitting combination indentations and fitting length of telescopic member and recess depth and the other keys are unfitting keys: FIG. 10A shows the lock set with the fitting key having the security element thereof in anon-obstructing position allowing the rotatable member to freely rotate in the stator of the lock set; FIG. 10B shows the cylinder lock and security element thereof having an unfitting key placed in the slot of the rotatable member of the cylinder lock, causing the security element to protrude from the outer wall of the rotatable member into the stator slot preventing thereby rotation of the rotatable member inside the stator; and FIG. 10C shows the cylinder lock and security element thereof having an unfitting key placed in the slot of the rotatable member of the cylinder lock, causing the security element to protrude from the outer wall of the rotatable member at another side thereof, also preventing thereby rotation of the rotatable member inside the stator of the cylinder lock.

FIGS. 11A and 11B show a lock set having cylinder lock and a key such as a blank master key or an indented key, according to other embodiments of the invention: FIG. 11A shows an exploded view of the lock set with the key; and FIG. 11B shows a perspective view of the secured lock set with the key inserted inside the cylinder lock.

FIGS. 12A and 12B show a lock set having a KIK (key in knob) cylinder lock, according to yet other embodiments of the invention: FIG. 12A shows an exploded view of the lock set with a key blank and FIG. 12B shows a perspective view of the secured lock set with a key blank inserted inside the cylinder lock.

FIGS. 13A and 13B show a lock set having cylinder lock, according to other embodiments of the invention: FIG. 13A shows an exploded view of the secured lock set with a key blank; and FIG. 13B shows a perspective view of the secured lock set with the key blank inserted inside the secured cylinder lock.

FIGS. 14A and 14B show a key blank, according to some embodiments of the present invention, having a telescopic member inserted through a designated opening over a side thereof for adapting thereof to a specific lock set cylinder lock having a security element with two or more protrusions by forming one or more recesses over the same or another side thereof in locations and properties such as depth and size that correspond to the protrusions of the security element they are to receive therein: FIG. 14A shows an elevated view of the key blank; and FIG. 14B shows a perspective view of the key blank.

FIGS. 15A and 15B show a key blank, according to some embodiments of the present invention, having a telescopic member inserted through a designated channel over a side of the key shank: FIG. 15A shows a perspective view of the key blank; and FIG. 15B shows a side view of the key blank.

FIG. 16 shows a perspective view of a key having combination indentations for specifically fitting to a specific lock set and a telescopic member, according to some embodiments of the present invention.

FIGS. 17A-17E show a wafer tumbler lock set (shortly referred to also as “lock set”) or parts thereof, the lock set including a cylinder lock unit and one or more fitting keys each fitting key having indentation designed to fit dimensions and locations of multiple wafers in the lock unit thereof and a telescopic member corresponding to a specific additional wafer member in the lock unit, according to some embodiments of the invention: FIG. 17A shows a perspective view of the lock set in a position in which the fitting key is inserted through the lock unit designated slot; FIG. 17B shows an exploded view of part of the lock set including the fitting key and a rotor (rotatable member) of the cylinder lock unit; FIG. 17C shows how a portion of the fitting key is inserted through the wafers for changing the positions of the wafers to align with each other such as to allow rotation of the rotor inside a stator of the cylinder lock unit for locking or unlocking; FIG. 17D shows a cross sectional view of an elongated side of the lock set, in which the fitting key is inserted inside the rotor of the lock unit; and FIG. 17E shows a transverse cross sectional view of the lock set, in which the fitting key is inserted inside the rotor of the lock unit.

FIGS. 18A-18B show the cylinder lock unit having an unfitting key that includes the correct combination indentations however does not include the telescopic member: FIG. 18A shows a cross sectional view of an elongated side of the cylinder lock and unfitting key; and FIG. 18B shows a cross sectional view of a transverse side of the cylinder lock and unfitting key.

FIGS. 19A and 19B show a key blank, according to some embodiments of the present invention, having a telescopic member inserted through a designated channel over a side of a key shank of the key blank: FIG. 19A shows a perspective view of the key blank; and FIG. 19B shows a frontal view of the key blank.

FIGS. 20A-20E show a wafer tumbler lock set (shortly referred to also as “lock set”) or parts thereof, the lock set including a cylinder lock unit and one or more fitting keys each fitting key having indentation designed to fit dimensions and locations of multiple wafers in the lock unit thereof and a telescopic member corresponding to a specific additional wafer member in the lock unit, according to some embodiments of the invention: FIG. 20A shows a perspective view of the lock set in a position in which the fitting key is inserted through the lock unit designated slot; FIG. 20B shows an exploded view of part of the lock set including the fitting key and a rotor of the cylinder lock unit; FIG. 20C shows how a portion of the fitting key is inserted through the wafers for changing the positions of the wafers to align with each other such as to allow rotation of the rotor inside a stator of the cylinder lock unit; FIG. 20D shows a cross sectional view of an elongated side of the lock set, in which the fitting key is inserted inside the rotor of the lock unit; and FIG. 20E shows a transverse cross sectional view of the lock set, in which the fitting key is inserted inside the rotor of the lock unit.

FIGS. 21A-21B show the cylinder lock unit having an unfitting key that includes the correct combination indentations however does not include the telescopic member inserted through its key slot: FIG. 21A shows a cross sectional view of an elongated side of the cylinder lock and unfitting key; FIG. 21B shows a cross sectional view of a transverse side of the cylinder lock and unfitting key; and FIG. 21C shows a perspective view of the wafers of the lock unit and the unfitting key engaging thereof.

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention provides key blanks, lock sets with cylinder locks and method of producing thereof, where the lock sets have auxiliary security mechanisms embedded therein for enhancing one or more locking and unlocking mechanisms of the cylinder locks thereof for improved safety and easy manufacturing, assembling and dismantling.

According to some embodiments, each lock set has a stator and a rotatable member (rotor) coaxially arranged for having the rotatable member rotating in the stator for locking and unlocking, and at least one security element placed inside a slot in the rotatable member in order to prevent rotation of the rotatable member inside the stator (for locking or unlocking) when a non-fitting key is used for instance and optionally when no key is inserted through the rotatable member's key slot. At least a portion of the security element protrudes from the outer wall of the rotatable member towards the stator or locks another part of the stator to protrude into the inner wall of the stator such as to prevent rotation of the rotatable member in the stator when no key or an unfitting key is used. The cylinder lock may also have one or more other standard locking mechanisms referred to herein as the additional locking mechanism(s) of the cylinder lock, such as the standard one or more sets of extendible pins enabling to lock and unlock by fitting into specific key indentations or wafers in case of a wafer tumbler lock design.

The key of the lock set has one or more telescopic elements placed inside corresponding one or more openings over one or more sides of the elongated portion of the key designed to be inserted into the cylinder lock. The telescopic pin will allow releasing an additional security locking mechanism in the cylinder lock such that if a key that has the right indentations will be used but does not include the fitting one or more telescopic members the rotor will still be prevented from rotating inside the stator preventing therefore the locking or unlocking thereof. The added security locking mechanism may include one or more additional security elements added to the cylinder lock.

The term “telescopic member” refers to any element or a set of elements connecting to one another that allow changing the length (shortening and/or extending) of the entire element, to protrude from the surface of one or more sides of the key in the extended state thereof and being aligned with the surface of the key side(s) or submerge below that(these) side(s) surface(s) when in the compressed state. The changing in length will occur upon applying of force over the telescopic member e.g. by pressing thereof (e.g. by the security element(s) of the lock) causing it to shorten/compress. To allow changing in length, the telescopic member may include one or more resilient elements such as a spring (coiled or non-coiled) connected at least at one end thereof to a cap that can protrude or submerge in a channel perforated in the shank of the key.

In a relaxed state of the resilient element, in which no force is applied over the telescopic member, the caps may protrude from the surface of the key.

According to some embodiments, one or more means for fixating at least one point or area of the resilient member or any other part of the telescopic member to the channel inside the key may be used, for preventing the telescopic member from being removed from that channel or from over-protruding therefrom. According to other embodiments, the telescopic member fits inside the channel such that it is blocked by the channel walls and thereby kept inside the channel for preventing the telescopic member from exiting the channel allowing only its extension and/or compression along an axis that will allow edges thereof to protrude and submerge from the openings of the channel or level with the surfaces thereof.

The security element pivotally connects to a wall cut formed by the side slot of the rotatable member via a hinge for instance. This side slot may be parallel to the axis of rotation of the rotatable member.

According to some embodiments, the stator has at least one groove in its inner wall that corresponds in length and location at least to the position and length of the security element such that when an unfitting key is used, the security element will rotate about an axis thereof and portion thereof will protrude from the outer wall of the rotatable member and be inserted into the stator groove preventing thereby the rotatable member from rotating inside the stator. When a fitting is used, the security element will reach a non-obstructing position, in which its outer side does not penetrate the slot groove for allowing the rotatable member to rotate in the stator. This position is achieved by causing the security element to rotate about its axis for instance.

According to some embodiments, the security element has an elongated shape having two or more protrusions.

According to some embodiments, the key of each lock set includes a key shank at least one recess disposed over a side of said key shank and at least one extensible member inserted inside the key shank and protruding from a side thereof. The extendible pin is designed to apply force over a protrusion of the security element engaging thereof, for causing the security element to rotate slightly about its axis for allowing one or more other protrusions thereof that do not engage the extendible pin to be inserted into their respective one or more recesses in the key. If an unfitting key is used having a recess or more which depth does not fit to receive the protrusion of the security element the security element maintain rotated such that a portion thereof will protrude from the rotatable member inside the stator groove obstructing thereby the rotation of the rotatable member in the stator.

Each recess over the side of the key is configured for receiving therein a protrusion of the security element such that the distance(s) between the protrusions of the security element exactly fit the distance between the key recess(es) and the telescopic member(s) locations and the depth of the at least one recess and the length of the telescopic member(s) when in a relaxed state fit, respectively, their corresponding security element's protrusions they are to engage.

According to some embodiments, an inner buffering means is used to maintain the security element in a “obstructing position” in which portion thereof protrudes into the stator groove to maintain this groove in the right alignment in respect to the side slot of the rotatable member preventing the rotatable member from rotating in the stator. The buffering means may include one or more springs located offset from the rotation axis of the security element engaging the security element such as to push a portion thereof towards the stator groove.

When a fitting key is inserted through the key slot, the security element will be rotated back from its original position inside the rotatable member becoming coplanar with the slot groove for allowing the rotatable member to rotate in the stator for locking or unlocking therewith. However, in a relaxed state or when an unfitting key will be inserted, even if the indentations on the upper or lower surfaces are identical to the fitting key in size, shape locations depths and height etc., the security element is slightly rotated about its fixation axis thereby have on either side thereof protrude from the outer wall of the rotatable member towards the stator groove for preventing rotation of the rotatable member thereby.

The security element's length, which determines the distance between its edge protrusions, is configured to fit the locations of the at least one telescopic member and the at least one recess of the one or more fitting keys of the lock set such that the distance between the recess and telescopic member is equal to the distance between the protrusions of the security element. The inner side wall of the rotatable member in which the security element is seated should also include indentations (recesses) for receiving therein the protrusions of the security element.

According to some embodiment each cylinder lock can have multiple security elements whereas a fitting key should have correspondently one or more telescopic members and recesses fitting the protrusions of all security elements of the lock set.

According to some embodiments, the additional locking mechanism of the cylinder lock includes a set of extendible pins such as telescopic pins located in the stator and protruding from holes in the rotatable member of the cylinder lock for locking and unlocking upon engagement with respective indentations in a fitting key.

Producing each of the one or more fitting keys for each lock set may include for instance, using a blank key having one or more holes for receiving the one or more telescopic members therein and one or more recesses over one or more sides thereof. The fitting of the key (e.g. by a locksmith) to the specific lock set i.e. to the specific design and location of its one or more security elements, is done by placing the one or more telescopic members into the designated hole(S) thereof over the blank key and forming one or more recess thereover that correspond to the location(s) of the protrusion(s) of the security element(s) each recess is to engage. The one or more recesses of each key of each particular design of a lock set may be formed by using simple available tools, where the size, location, depth and shape of each recess is determined according to the properties of its matching security element protrusion.

The blank key may be marketed with one or more standard one sized telescopic members already placed in their holes such that specifying of each key to its corresponding lock set will simply require indenting the one or more recesses thereover. In these cases, one or more designs of key blanks may be available each having one or more telescopic members in the key blanks.

The fitting keys production out of the blank keys for fitting to their respective lock sets and their special security element's design, may additionally include indenting the key blanks after or before the forming of their recesses to fit to an additional locking mechanism of the lock set.

The lock sets of the present invention can be used for any kind of lock such as a door lock or as a vehicle starter lock and the like for actuating a bolt, closing an electric circuit or any actuation a cylinder lock is used for. For example, the cylinder lock is a mortise or bored lock having a gear cam having one or more protruding elements for ultimately pulling or pushing a latch bolt of a latch assembly installed in the door. In other cases the rotation of the rotational member closes an electric circuit for starting a vehicle or even switching on or off any other device or machine.

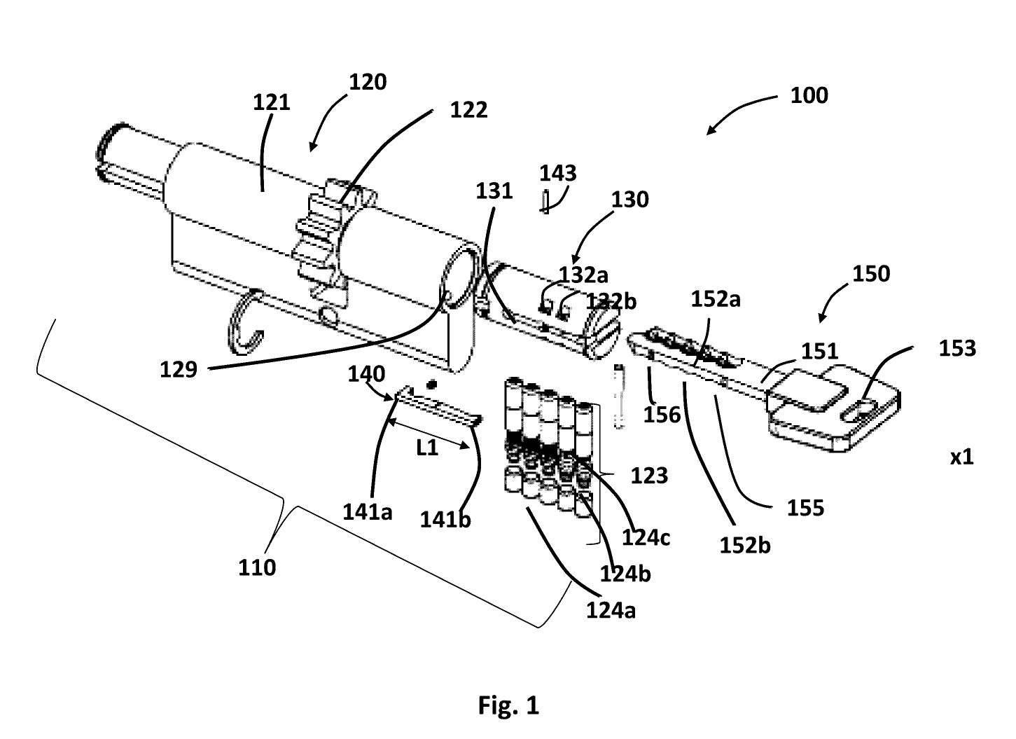

Reference is now made to FIGS. 1-4, which show a lock set 100, according to some embodiments of the present invention, or parts thereof.

The lock set 100 includes: a cylinder lock assembly 110 comprising a stator 120 having an inner stator groove 129, a rotatable member 130 having a key slot 131a and a side slot 131b and a security element 140; and one or more key such as key 150 configured for fitting thereto at least for fitting to the security element 140 such as to allow the security element 140 to be positioned in a non-obstructing position, when the key 150 is inserted to the key slot of the rotatable member. The non-obstructing position is defined herein as a position in which the security element 140 or any portion thereof does not protrude from the outer wall of the rotatable member 130 through its side slot 131b and therefore no part thereof is inserted into the stator groove 129 allowing thereby the rotatable member 130 to rotate in the stator 120. In the non-obstructing position of the security element 140 its outer side is parallel to the rotation axis “x1” of the rotatable member 130 and is either surfaced with its outer wall or slightly sunken in the side slot 13b1 thereof.

As shown in FIG. 1, the stator 120 has the groove 129, a cylindrical body 121 and a gear cam 122 as well as a set of extendible pins 123 having multiple telescopic pins 124c each engaging a spring 124b connected to a pin base 124a thereof. The key 150 includes a key head 153, a key shank 151 having upper and lower indentations 152a and 152b, respectively for moving the pins 124c of the stator 120 for locking and unlocking the additional locking mechanism thereof.

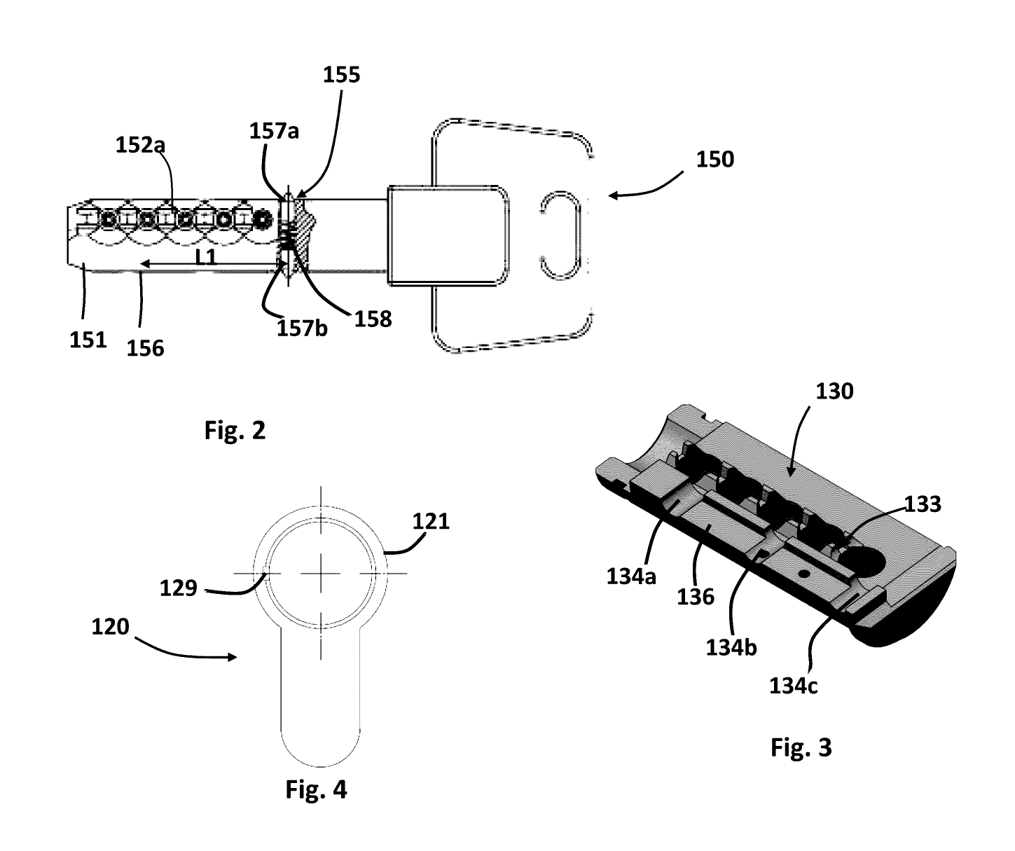

The key 150 also includes a coded recess 156 and a telescopic member 155 located at a side thereof that is not indented distant from one another in a distance L1 that corresponds to the distance L1 between the edges 141a-241b of the security element 140. FIG. 2 shows details of the telescopic member 155 of the key 150 allowing it to change in length by compressing or decompressing a spring 158 thereof in response to forces applied thereover in the direction (axis) of protrusion thereof. The spring 158 connects to pins 157a and 157b at edges thereof.

As shown in FIG. 1 and FIG. 3, the rotatable member 130 includes the key slot 131a designed for receiving the key 150 therein from one side thereof and the side slot 131b, which in this case is separated therefrom for placing the security element 140 therethrough. This side slot 131b forms a side wall 136 over the rotatable member 130 to which the security element 140 is pivotally connected via a hinge 143 wherein protrusions 141a-141b of this security element 140 will be positioned within recesses (indentations) 134a-134c of that rotatable member 130 side wall 136.

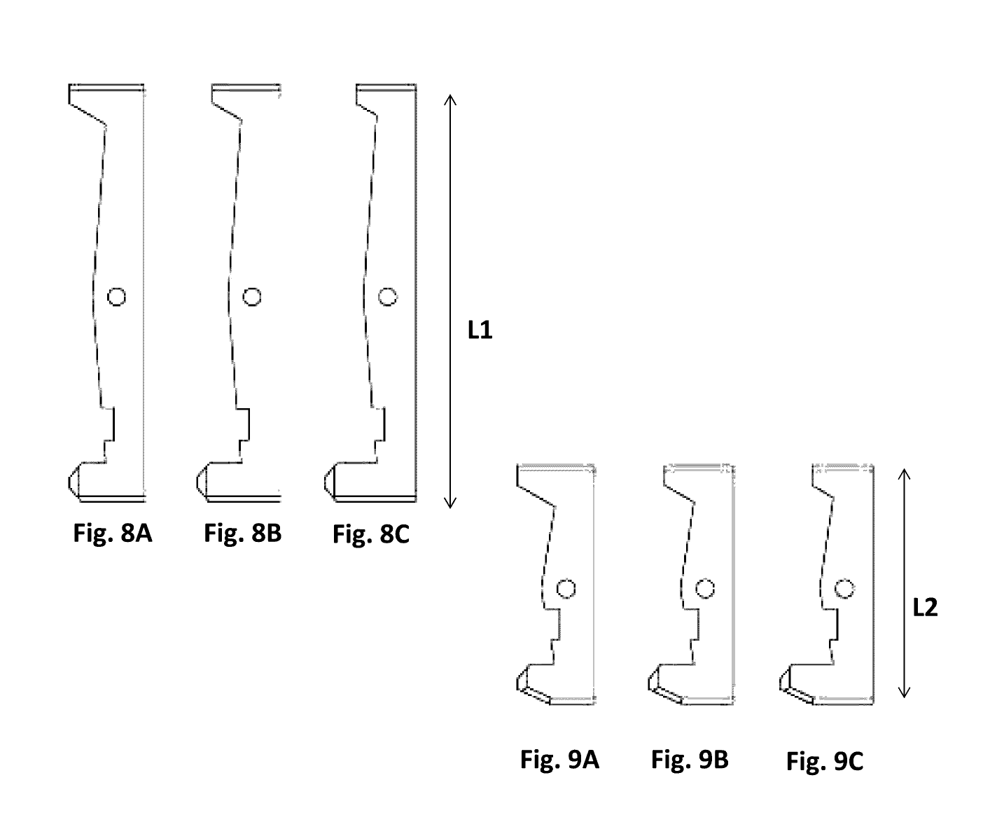

As illustrated in FIG. 3, the side wall 136 includes three recesses 134a-134c for manufacturing the same rotatable member 130 that will fit at least two types of security elements each having a different overall length “L1” or “L2” (see FIGS. 8A-9C). Each type of security element can have the same length but vary in the size and optionally also the number of its protrusions for uniquely fit only the keys having the corresponding telescopic member(s) and recess(es).

In this way the same stator and the same rotatable member can be mass produced changing only the type and shape of the security element for uniquely defining the keys that can be used for locking and unlocking the specific lock set therewith.

As shown in FIG. 3, the rotatable member 130 also includes openings 133 for receiving therethrough the extendible pins 123 of the additional locking mechanism of the cylinder lock 110.

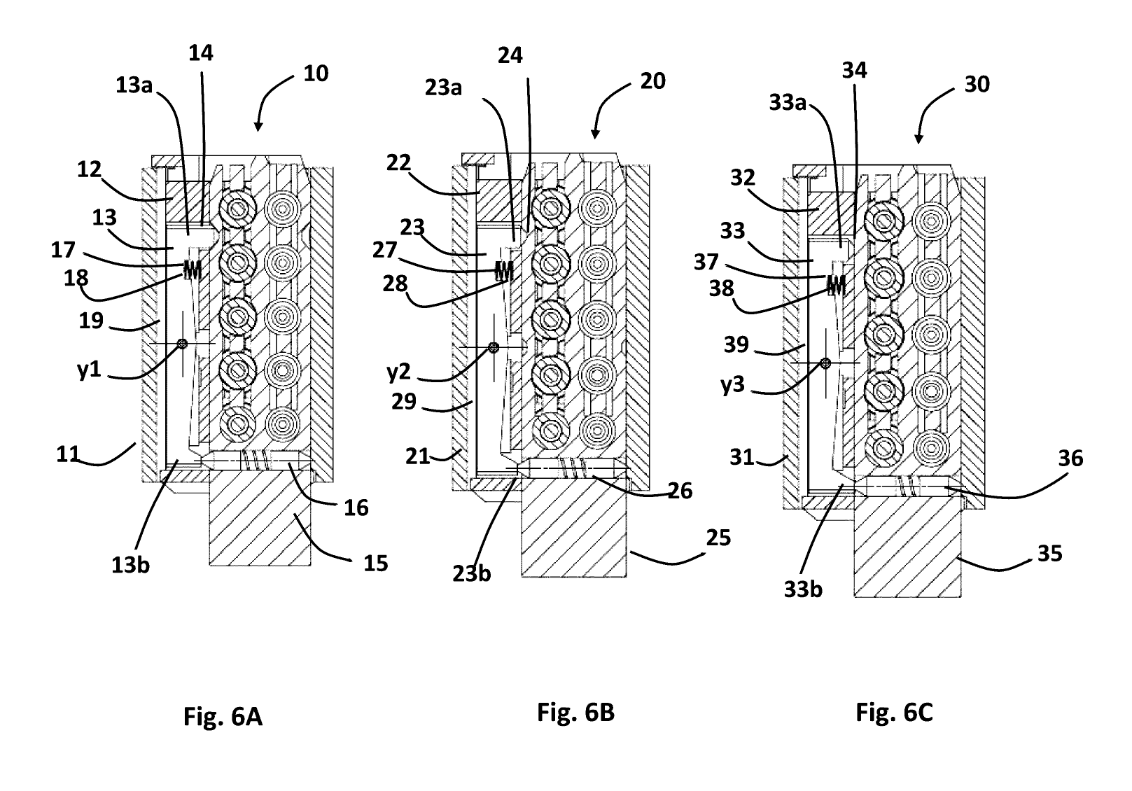

As shown in FIG. 1, the rotatable member 130 is coaxially positioned in the stator 120 defining a rotation axis x1 thereof. When no key is inserted through the key slot 131a, the security element 140 should be maintained such that a portion of its outer wall is inserted through the stator groove 129 unless a fitting key is placed retracting the security element by rotating thereof about its axis such that it will not protrude from the outer walls of the rotatable member 130 for allowing it to rotate in the stator 120. To maintain the security element 140 protruding into the stator groove 129 one or more buffering means (not shown) can be used as will be illustrated in FIGS. 6A-6C.

According to some embodiments, the rotatable member 133 also includes two holes 132a and 132b for allowing inserting the security element hinge 147 through any of them depending on the desired location of the hinge 147 (hole 132a for the shorter security element and hole 132b for the longer one).

According to other embodiments, the security element 140 is maintained in a non-obstructing position also when no key is inserted through the key slot, in which cases the opening of an unfitting key will actively cause the rotation of the security element for bringing it to the obstructing position thereof.

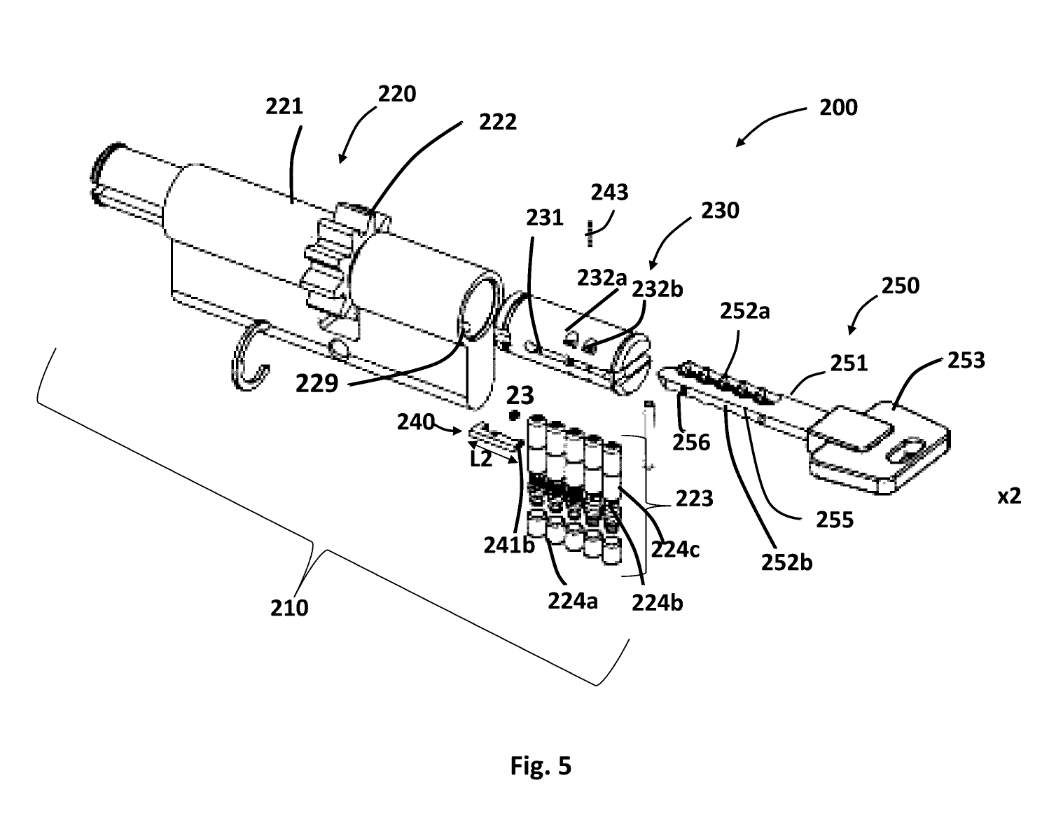

FIG. 5 shows an exploded view of a lock set 200 having a similar cylinder lock 210 design as cylinder lock 110 using a different length type of security element 240, which is shorter than the security element 140, according to some embodiments of the present invention. The components of the cylinder lock 210 of: a stator 220 having a cylindrical body 221 with an inner groove 229, a gear cam 222, and an extendible pins set 223 are similar in location, design and sizes to their corresponding components 120, 129, 121, 122, and 123 of cylinder lock 110. The locations of the holes 232a-232b are also in the same positions as in 132a-132b, respectively as well as the shape size and location of the side slot 231 for allowing selecting where to insert the security element hinge 243 from. However, the use of a security element 240 of a different length L2 having its protrusions 241a-241b located at a different distance from each other than the distance between the edges 141a-141b of the security element 140, will require using a key 250 having its telescopic member 255 and recess 256 located at a distance from one another that corresponds to the length L2 of the security element 240.

The key 250 also includes a key head 253, a key shank 251 having upper and lower indentations 252a-252b corresponding to the extendible pins 223 each including a pin head 224c connected to a base 224a via a spring 224b.

For reducing manufacturing costs and resources, each key may be configured out of a generic blank key forming one or more holes at a predefined location(s) thereover, for receiving the one or more telescopic member(s) therein and on or more recesses of varied depths and optionally varied shapes for allowing specifying the key to the unique lock by inserting a different length telescopic member into the designated hole, optionally also forming recesses of different depths for each lock set, and by forming the unique indentation pattern of the specific key to fit the cylinder lock specific extendible pins set.

The security mechanism, including the security element placed in the designated slot thereof and the telescopic member(s) and recess(es) in the key may be used as a single locking mechanism of the lock set or added as an auxiliary locking mechanism to one or more additional locking mechanisms that will also increase the number of possible combinations for each lock set design using only two or more limited number of different security element sizes and designs to form unique combinations.

In this case the first stage of mass production of lock sets eventually forming a unique locking specifications therefore, will be to form multiple duplicate stators of the same shape and size (including their cam or any other latching mechanism) and multiple duplicate rotatable members and providing multiple blank keys and then forming the hole(s) and recess(es) thereover; then a set of two types of security elements may be manufactured having the edges of each element being cut at a unique manner for specifying thereof to a single lock set.

In some embodiments the production also includes mass producing telescopic members of the same length shape and size with coiled springs of the same properties or of varied sizes and properties selected form a limited number of optional designs to fit various lock sets.

Optionally, if the lock set uses one or more additional locking mechanisms the production also involves specifying each lock set by selecting a different set of extendible pins and indenting the sides of the keys thereof correspondently. In this way the key has to fit to both the security element length, edges distances and lengths (and optionally unique shape) as well as to the extendible pins of the cylinder lock for enabling using thereof.

Since there are many components of different nature that have to fit to one another, unauthorized duplication of such keys will be nearly impossible as well as using a master key.

Any number of security elements lengths can be used depending on manufacturing costs and other considerations as well as any design thereof (i.e. number of protruding edges thereof and shape of each edge etc.).

Any number of designs of telescopic members can also be used such as a single unified design for reducing production costs or multiple designs.

Any type of known in the art locking mechanism can be used for the additional locking mechanism if such is used and not necessarily or solely the extendible pins locking principle.

FIGS. 6A-6C show cross sectional views of three different lock sets 10, 20 and 30 having a security element 13, 23 and 33 of a specific first type having the same overall length L1, differentiated from one another by the length of protrusions of their security elements requiring different key recess and/or telescopic member sizes for each: FIG. 6A shows a lock set having a security element in which the first protrusion 13a is longer than the second protrusion 13b; FIG. 6B shows a lock set having a security element in which the first protrusion 23a is longer than the second protrusion 23b; and FIG. 6C shows a lock set having a security element in which both protrusion 33a and 33b are of the same length. Each lock set 10, 20 and 30 has the fitting key thereof 15, 25 and 35 inserted through the designated key slot of the respective cylinder lock of the lock set.

Each of the lock sets 10, 20 and 30 has a stator 11, 21 and 31 respectively, with a stator groove 19, 29 and 39 slotted over its inner wall, a rotatable member 12, 22 and 32 having a slot forming a side surface having indentations for receiving therein protrusions 13a and 13b, 23a and 234b and 33a and 33b of their respective security elements 13, 23 and 33. Each security element 13, 23 and 33 is pivotally connected to its respective rotatable member 12, 22 and 32 via a hinge and is rotatable about an axis y1, y2 and y3 thereof. Each lock set of 10, 20 and 30 has a spring buffering element 18, 28 and 38 designed to be received by a designated recess 17, 27 and 37 of the security element 13, 23 and 33.

Each key 15, 25 and 35 has an telescopic member 16, 26 and 36 and a recess 14, 24 and 34 of a different depth for engaging the fitting keys thereof such that the security elements 13, 23 and 33 will reach the non-obstructing position thereof when their respective fitting keys 15, 25 and 35 are fully inserted in their respective key slots, by rotating about their respective axes y1, y2 and y3 when their fitting keys 15, 25 and 35 are inserted to push out portions of the security elements 13, 23 and 33 that protruded into the grooves 19,29 and 39 before the keys were inserted due to force applied thereover by the buffering element 18, 28 and 38.

The buffering elements 18, 28 and 38 are located offset from the rotation axes y1, y2 and y3 of the security elements 13, 23 and 33, respectively, and on an opposite side of that axis y1, y2 or y3 in respect to the telescopic members' 16, 26 and 36 locations so as to also counterpoise thereof. The extendible pin 16, 26 and 36 are extended in response to the length of their corresponding security element's second protrusion 13b, 23b and 33b for engaging therewith by simply being pushed towards the key away from the rotatable member's inner walls by the second protrusion 13b, 23b and 33b.

As mentioned above, the main purpose of the buffering elements 18, 28 and 38 is to maintain the security elements 13, 23 and 33 in their obstructing position when no key is placed in the rotatable members' 12, 22 and 32 key slots.

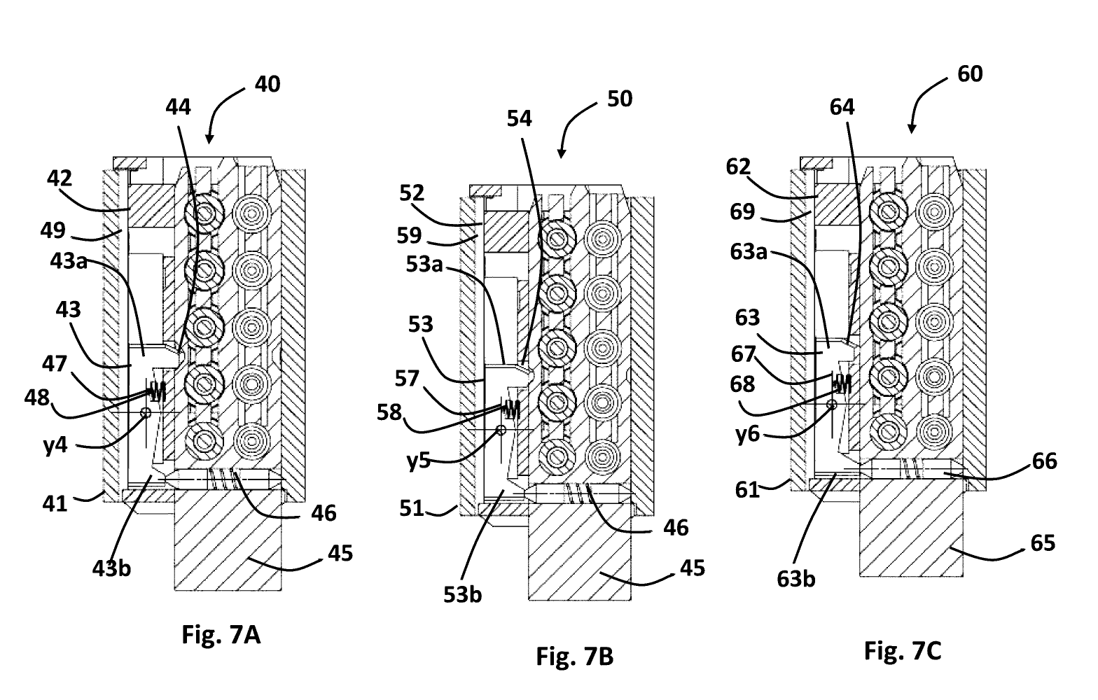

FIGS. 7A-7C show cross sectional views of three different lock sets 40, 50 and 60 having a security element 43, 53 and 63 of a specific second type having the same overall length L2 which is shorter than L1. Each lock set 40, 50 and 60 has the fitting key thereof 45, 55 and 65 inserted through the designated key slot of the respective cylinder lock of the lock set.

Each of the lock sets 40, 50 and 50 has a stator 41, 51 and 61 respectively, having a stator groove 49, 59a and 69 indented in its inner wall, a rotatable member 42, 52 and 62 having a slot forming a side surface having indentations for receiving therein protrusions 43a 53b, 63a and 43b, 53a and 63b of their respective security elements 43, 53 and 63. Each security element 43, 53 and 63 is pivotally connected to its respective rotatable member 42, 52 and 62 via a hinge and is rotatable about an axis y4, y5 and y6 thereof. Each lock set of 40, 50 and 60 has a spring buffering element 48, 58 and 68 designed to be received by a designated recess 47, 57 and 67 of the security element 43, 53 and 63.

The buffering elements 48, 58 and 68 are located offset from the rotation axes y4, y5 and y6 of the security elements 43, 53 and 63, respectively, and on an opposite side of that axis y4, y5 or y6 in respect to the telescopic members' 46, 56 and 66 locations so as to counterpoise thereof.

As mentioned above, FIGS. 8A, 8B and 8C show different security elements of the first type having the same overall length L1 and varied protrusions lengths and/or inner indentations sizes and/or locations and FIGS. 9A, 9B and 9C show different security elements of the second type having the same overall length L2, whereas L1>L2. These form a set of six possible different security elements allowing having 1,449,459 combinations of unique lock sets for cylinder locks thereof having five extendible pins locking mechanism.

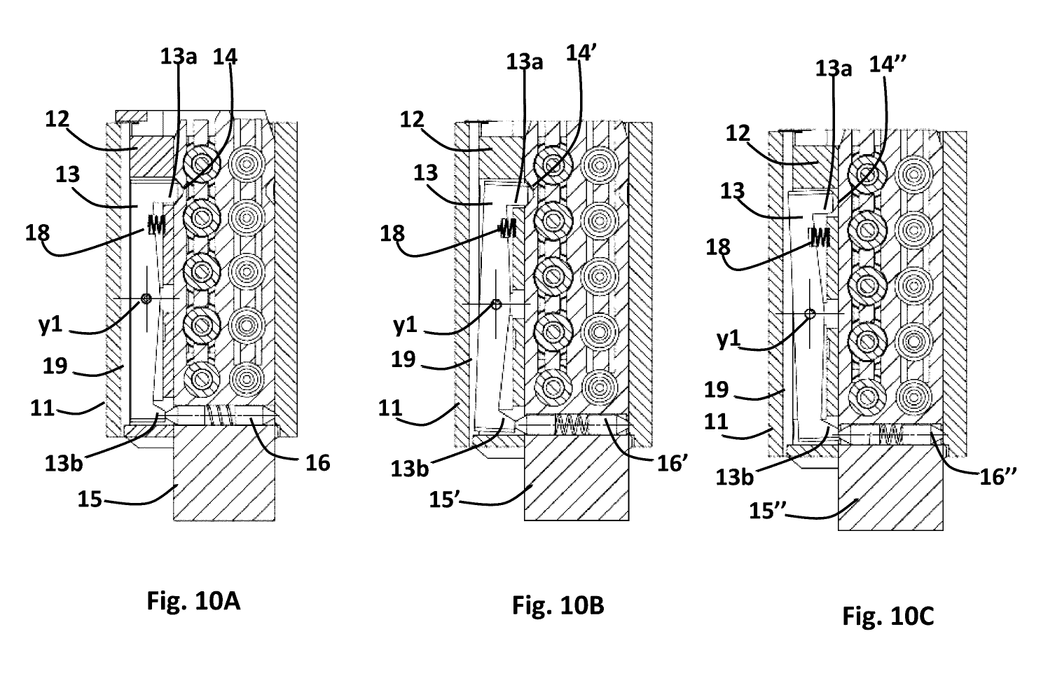

FIGS. 10A-10C show how using unfitting keys such as keys 15′ and 15″ for attempting to rotate the rotatable member 12 of the same lock set 10 will maintain the security element 13 of the lock set in its obstructing position, in which a portion thereof protrudes towards the stator 11 inner wall and inside the stator groove 19.

FIG. 10A shows the lock set 10 with the fitting key 15 inserted thereto.

In this case the security element 13 outer side wall is parallel to the rotation axis of the rotational member 12 and does not protrude from its outer wall thereby allowing rotation of the rotatable member 12 inside the stator 11, since the spring of the telescopic member 16 applies a force that counterpoise the one applied by the spring 18 of the buffering element of the cylinder lock.

FIG. 10B shows an unfitting key 15′ inserted through the key slot of the cylinder lock rotatable member 12 having a recess 14′ that is too deep, causing the telescopic member 16′ of the key to push the first protrusion 13a of the security element 13 further into the too deep recess 14′ thereby causing the portion of the security element 13 to protrude from the outer wall of the rotatable member 12 into the stator groove 19 preventing the rotatable member 12 from rotating in the stator 11.

FIG. 10B shows an unfitting key 15′ inserted through the key slot of the cylinder lock rotatable member 12 having a recess 14′ that is too shallow, causing the telescopic member 16′ of the key to push the first protrusion 13a of the security element 13 causing the lower portion of the security element 13 to protrude from the outer wall of the rotatable member 12 into the stator groove 19 preventing the rotatable member 12 from rotating in the stator 11.FIG. 9C shows an unfitting key 15″ inserted through the key slot of the cylinder lock rotatable member 12 having a recess 14″ that is too shallow, causing the telescopic member 16″ thereof to be pushed backwards towards the key and thereby causing the upper portion of the security element 13 to protrude from the outer wall of the rotatable member 12 into the stator groove 19 preventing the rotatable member 12 from rotating in the stator 11.

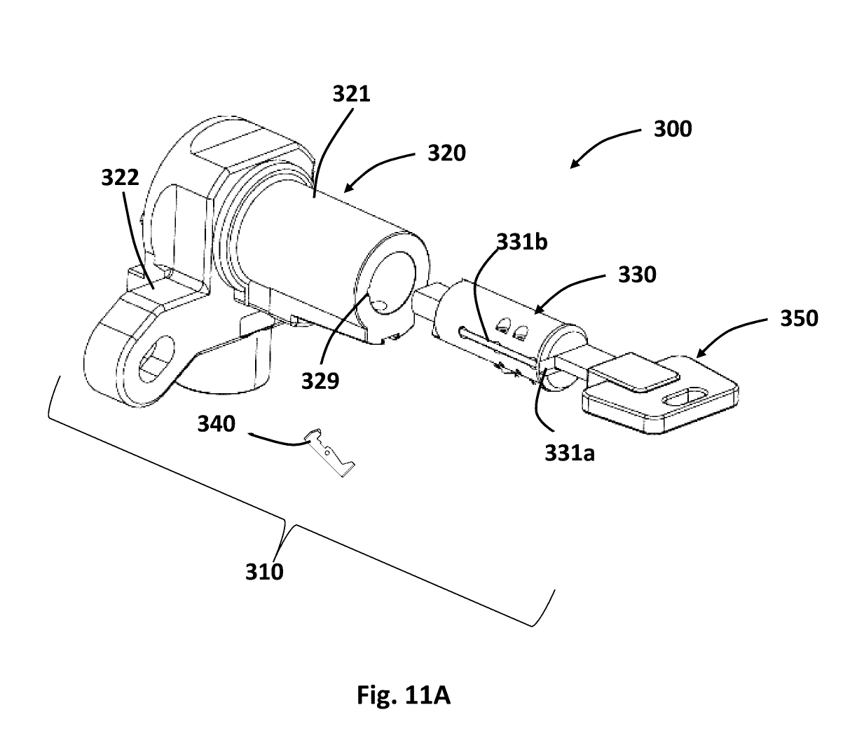

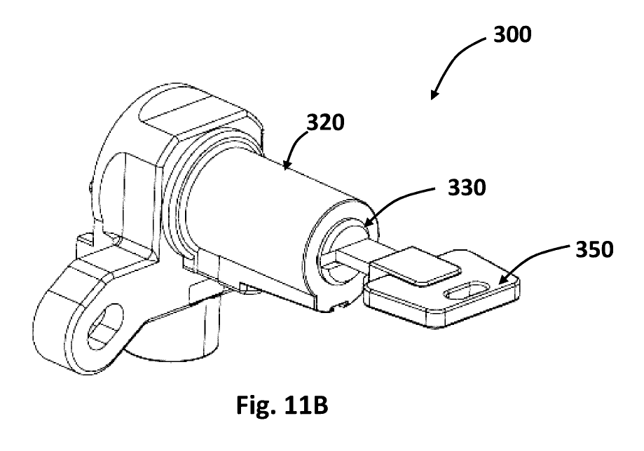

FIGS. 11A and 11B show a lock set 300, according to other embodiments of the invention, having a cylinder lock 310 additional locking mechanism, a stator 320 having a stator body 321 with a stator groove 329 slotted through its inner wall, the body 321 being connectable to a cam 322 and a rotatable member 330 having a key slot extended to a side slot 331 for receiving a security element 340 therein and a designated fitting key 350 additional locking mechanism; a rotatable member 330 with a key slot 331a and a side slot 331b for receiving therein the security element 340.

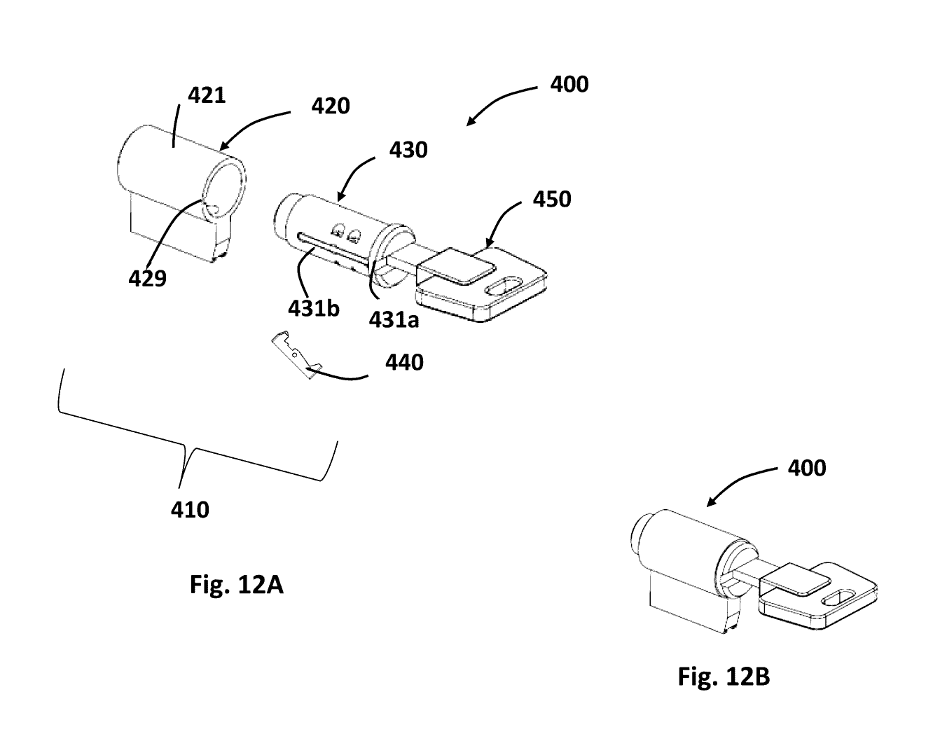

FIGS. 12A and 12B show a lock set 400 having a KIK (key in knob) type cylinder lock 410, according to yet other embodiments of the invention. The cylinder lock 410 includes a stator 420 having a cylindrical stator body 421 with a stator groove 429 slotted over its inner wall, and a rotatable member 430 coaxially inserted in the stator 420. The rotatable member 430 has a designated key slot 431a for receiving therein the elongated portion of the key 450 of the set 400 and a side slot 431b for receiving from a side thereof a security element 440. additional locking mechanism

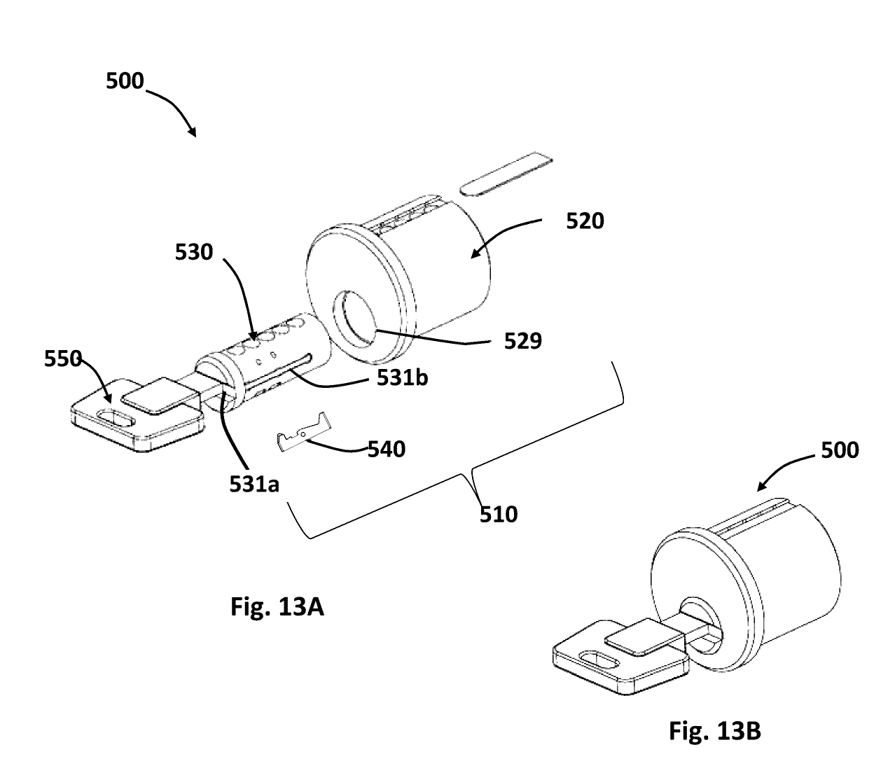

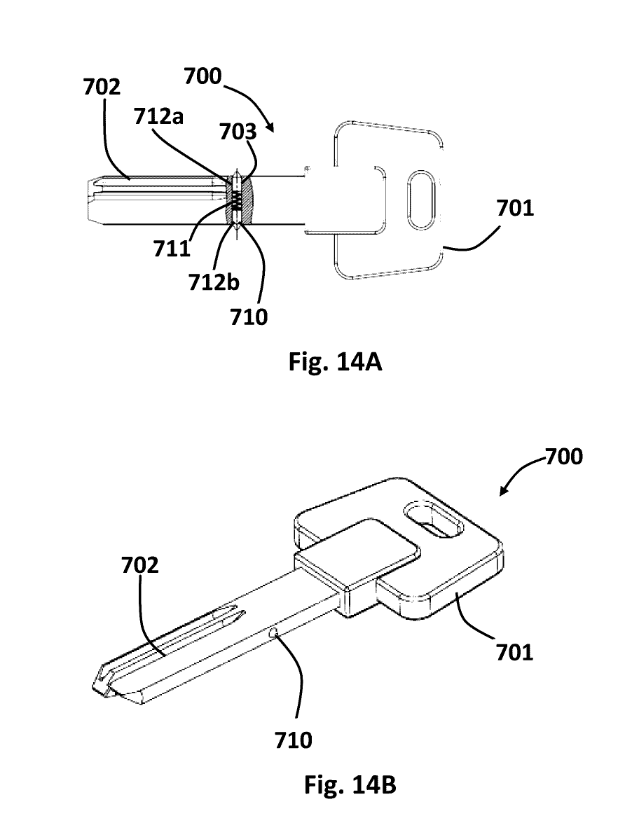

FIGS. 13A and 13B show a lock set 500 including cylinder lock 510, according to other embodiments of the invention. The cylinder lock 510 includes a rotatable member 530 and a cylindrical stator 520 configured for coaxially receiving therein the rotatable member 530. The rotatable member 530 has a designated key slot 531 for receiving therein the elongated portion of the key 550 of the set 500 and a side slot 531 for receiving from a side thereof a security element 540. The stator 520 has a cylindrical body with a stator groove 529 slotted over an inner wall thereof.

As mentioned above any number, shapes and sizes of protrusions can be used for the security elements and any corresponding number shapes and sizes of telescopic members and recess can be used for the fitting keys thereof, where the number of protrusions and variations of their shapes and sizes as well as variations of the lengths of the security elements determine the number of possible combinations for unique lock sets combined with the number of possibilities for the additional locking mechanisms.

The structural concepts of the present invention allow using very few groups of mass produced security elements having very few unified designs and corresponding keys' recesses and telescopic members to yield a large number of possible unique locking combinations when incorporated with the combinations enabled from the additional locking mechanism.

The method for manufacturing such lock sets involve, in some embodiments, providing generic components of cylinder locks of a single type and design including the same mass produced duplicate stators, rotatable members and the same generic key blanks (before indenting one or more recesses and/optionally before forming the telescopic member(s) hole(s) and only manufacture multiple pieces of security elements of singular designs and then forming the recesses at the side(s) of each key in location(s) and depth(s) that correspond additional locking mechanism to the security element size and design for each lock set to specify it.

If the lock sets should have another additional locking mechanism such as the extendible pins based mechanism, coded indentation over the key are also to be formed as well as opening of designated extendible pins into the rotatable member in designated recesses thereof.

The present invention also provides one or more key blanks each having a key shank and one or more telescopic members such as described above inserted through one or more designated holes in the key shank for allowing duplication or formation of a specific unique key for each cylinder lock of each lock set by forming one or more recesses over one or more sides of the key shank thereof that fit in size, depth and location to one or more of the protrusions of the security element of the cylinder key. Each recesses will be located such that when the key member is inserted through the key slot of the rotatable member of the cylinder lock, it will receive therein a corresponding security element or portion thereof such that all protrusions that are inserted through the key one or more recesses will allow rotation of the security element to its non-obstructing position.

The present invention further provides a method for adapting a key blank, having one or more telescopic members therein, to a specific cylinder lock having the stator, the security element and the rotatable member as described above by forming one or more recesses over at least one side thereof in locations and properties such as shape and/or depths that correspond to length and locations of at least one of the protrusions of the at least one security element in the cylinder lock.

Reference is now made to FIGS. 14A and 14B showing a key blank 700 according to some embodiments of the present invention, having a key head 701 FIGS. 14A and 14B show a key blank of some embodiments of the present invention, having a telescopic member inserted through a designated opening over a side thereof for adapting thereof to a specific lock set cylinder lock having a security element with two or more protrusions by forming one or more recesses over the same or another side thereof in locations and properties such as depth and size that correspond to the protrusions of the security element they are to receive therein, a key shank 702 and a telescopic member 710 inserted through a designated opening 703 over a side of the key shank 702 for adapting thereof to a specific lock set cylinder lock. The specific lock includes a security element with two or more protrusions and the adaptation of the key blank to form a fitting key to the specific cylinder lock security element is done by forming one or more recesses over the same or another side thereof in locations and properties such as depth and size that correspond to the protrusions of the security element they are to receive therein

The telescopic member 710 includes a spring 711 FIGS. 14A and 14B show a key blank of some embodiments of the present invention, having a telescopic member inserted through a designated opening over a side thereof for adapting thereof to a specific lock set cylinder lock having a security element with two or more protrusions by forming one or more recesses over the same or another side thereof in locations and properties such as depth and size that correspond to the protrusions of the security element they are to receive therein and two pins 712a and 712b each engaging or connecting to a different spring edge and can protrude from each side of the opening 703 in the key member 702.

As mentioned above to form a key that fits to a specific cylinder lock e.g. for completing the lock set in the production stage or for duplicating a key for the cylinder lock the individual producing the fitting key such as a locksmith should form one or more recesses, each at a specific location i.e. at a specific distance from the telescopic member 710 and from one another that correspond to the distances between the protrusions of the cylinder lock's security element.

The one or more recesses forming should be done such that each recess will have properties such as depth, size, shape and the like that will allow their corresponding protrusion to fit into the recess in a manner that will allow rotating the security element to reach the non-obstructing position when the fitting key formed thereby is inserted into a key slot of the cylinder lock rotating its rotatable member inside the stator thereof.

The present invention, in some embodiments thereof provides a lock set that includes at least: (i) a cylinder lock and at least one fitting key fitting of the specific lock unit.

According to some embodiments, the lock unit includes a stator; a rotor configured for being coaxially situated in the stator for rotating therein, where the rotor has a key slot for receiving a key therein and one or more wafer openings or recesses; a moveable element operatively associated with the rotor such that once the rotor is rotated in the stator it moves the moveable element for operating the lock unit e.g. by locking or unlocking or by switching and/or closing an electric circuit for starting an engine and the like; a first locking mechanism such as a wafer tumbler based locking mechanism; and an additional security mechanism including one or more wafer units, each inserted through a respective wafer opening in the rotor.

The fitting key may include a key head and a key shank with at least one combination indented, grooved, engraved and/or etched over at least one side thereof and one or more telescopic members each inserted in a designated channel perforated in the key shank of the fitting key. Each telescopic member may be configured such that it can change at least in length in response to a force applied thereover and return to a predefined relaxation state length.

According to some embodiments, each wafer unit of the additional security mechanism is located and configured for engaging at least one edge of a telescopic member of the fitting key when inserted through the key slot such that each telescopic member will move the respective wafer unit it engages such that the fitting key will enable to release the additional security mechanism and the first locking mechanism for positioning the rotor in a released rotor position, in which the rotor is freely rotatable in the stator.

The term release or releasing etc. of the rotor used herein refers to any removing of blocking elements or releasing blocking mechanisms that prevent the rotor from rotating inside the stator for allowing the rotor's rotation. Once the rotor can move in the stator it can be rotated for operating the moveable element e.g. for locking or unlocking therewith for example a door or for switching on or off for example a vehicle starter switch and the like.

The present invention, according to other aspects thereof, provides a key blank having a key head; a key shank having at least one channel perforated over at least one side thereof; and at least one telescopic member each inserted in each channel in the key shank. According to some embodiments, each telescopic member of the key blank has at least one resilient element such as a coiled spring or a leaf spring and two cap elements each cap element being located at a different edge of the resilient element.

According to some embodiments, the telescopic member is configured such that it is changeable in length in response to a force applied thereover and returnable to a predefined relaxation state length.

Additionally or alternatively, the telescopic member is located and configured such as to engage at least one corresponding second wafer of a wafer tumbler lock unit for moving it to allow rotation of a rotor of this lock unit inside a stator thereof.

According to other aspects of the present invention, there is provided a key blank having a key head; a key shank connected to the key head and having at least one channel perforated over at least one side thereof; and at least one telescopic member each inserted in each channel. Each telescopic member of the key blank has a resilient element and two cap elements each cap element being located at a different edge of the resilient element. In these embodiments, each telescopic member of the key blank and channel thereof is located over the key shank proximally to the key head and before an area over the key shank that is to be indented for specifying of the blank key, where each channel is located such that at least one of the cap elements of the telescopic member located therein is protrudable from at least one side of the key shank that is perpendicular to one or more sides of the key shank that is to be indented. This means that the channel's openings are located over sides of the key shank that are perpendicular or angular to the side(s) of the blank key shank that is to be indented and in the edge of that shank that is closer to the key head for allowing easy blanks manufacturing and easy indentation of the key blank for specifying thereof after the channel(s) is(are) perforated over the shank for receiving the telescopic member(s) therein.

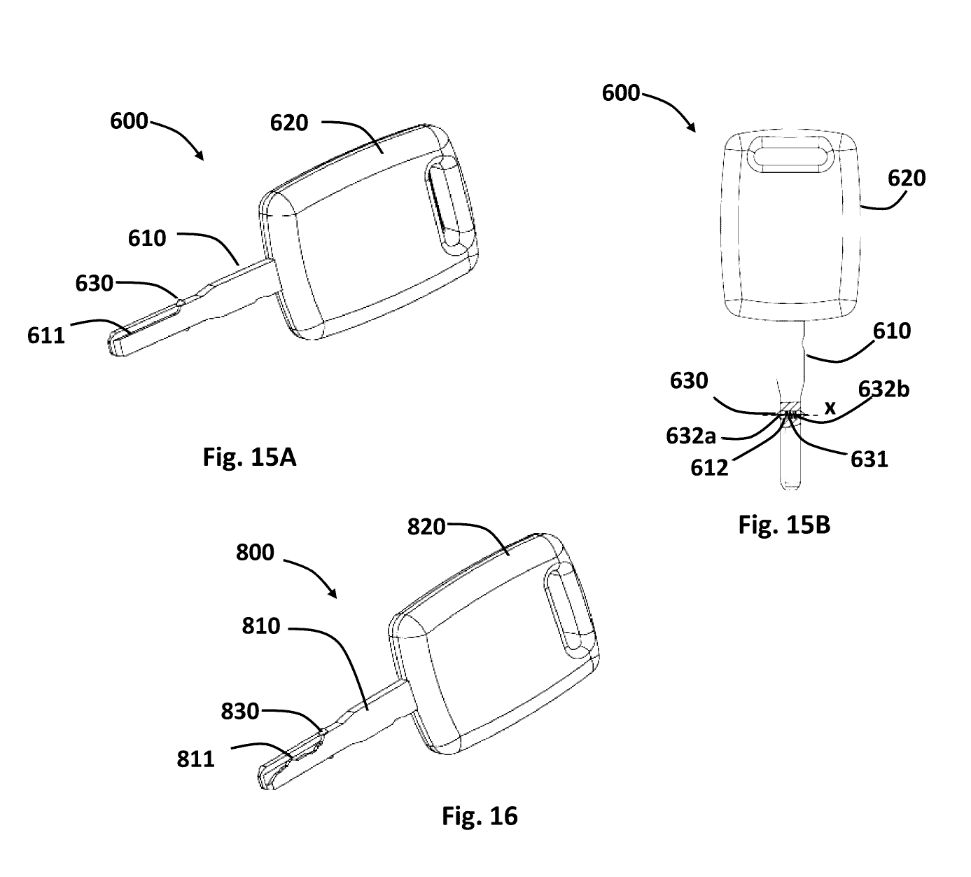

Reference is now made to FIGS. 15A-15B showing a key blank 600 having a key head 620, a key shank 610 and a telescopic member 630 inserted through a channel 611 perforated over the key shank 610. The channel 612 and therefore the telescopic member 630 inserted therethrough is located proximally to the key head 620 for allowing indenting the one or more sides of the key shank 610 for specifying the key blank 600. The telescopic member 630 as shown in the cross sectional area of FIG. 15B, includes a coiled spring resilient element 631 connected at ends thereof to cap elements 632a and 632b. When in a relaxed state, in which no force is applied over the spring 631 along the axis x along which it contracts/compressed and extends, the cap elements 632a and 632b protrude from the key shank 610 sides and will be pressed inwardly when a force is applied thereover by the one or more security elements of the lock unit to which it will be adapted. The key shank 610 of the key blank 600 has at least one side thereof such as side that is designated for being indented for specifying the key to a particular lock unit, e.g. by creating recesses thereover or by creating an indented protrusion over a protruding member 611 thereof. Each side of the key blank that is to be indented is perpendicular to the sides in which the openings of the channel 612 are located. In other embodiments the sides of the shank 610 having the openings of the channel(s) for the telescopic member(s) can be angular and not necessarily perpendicular to the side(s) to be indented.

FIG. 16 shows a specified key 800 which is the key blank 600 indented over two sides thereof. The specified key 800 has a key head 820 and shank 820 and a telescopic member 830 inserted through a channel perforated through a side of the shank 810. It is clear to see that the indentations 811 are made over sides of the key shank 810 that are perpendicular to the key shank 810 sides from which the telescopic member 830 cap elements protrude.

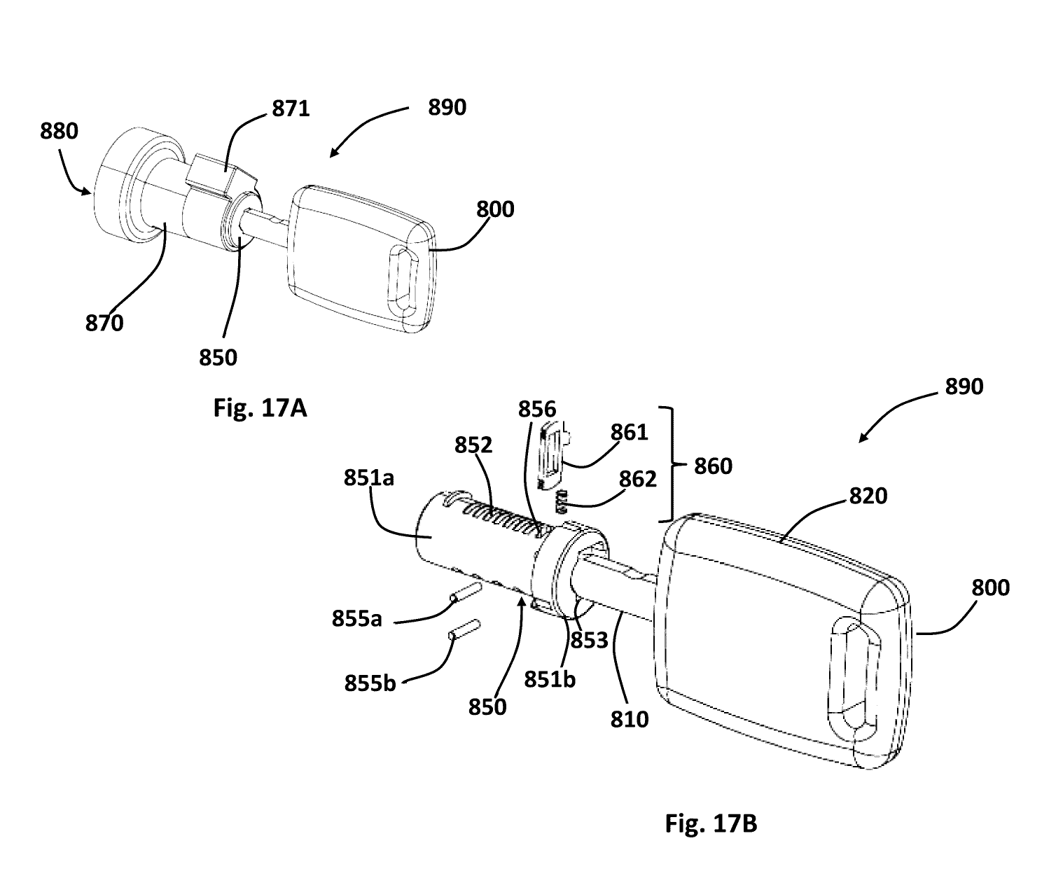

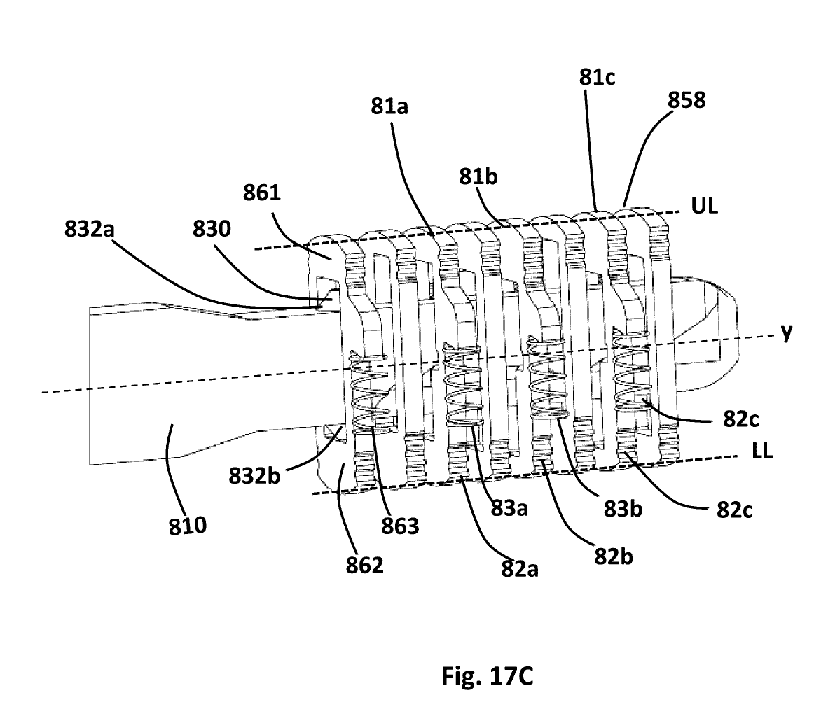

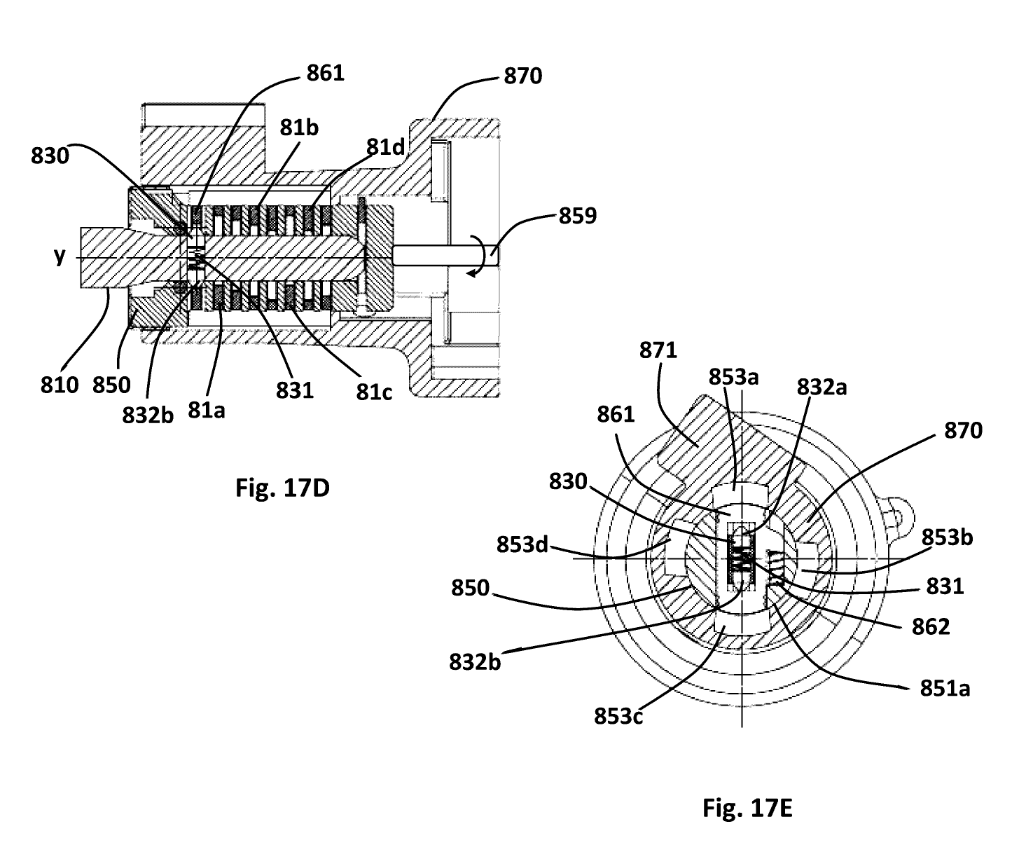

Reference is now made to FIGS. 17A-17E showing a lock set 890 including a lock unit 880 and the key 800 fitting thereto. The lock unit 880 is a wafer tumbler lock type unit for a starter switching mechanism or for a locking mechanism having a stator 850 and a rotor 870 and multiple wafers. The rotor 850 includes two cylinders 851a and 851b integrally connected to one another having a key slot 853 for receiving the key 800 therein and multiple wafer openings 852 and 856 for receiving therein multiple first set of wafer units such as wafer units 81a-81c and another wafer unit 861 which is the additional security mechanism (see FIG. 17C). A base structure 858 having embedded wafer like structures therein holds all wafer units 861 and 81a-81c. Each wafer unit such as units 861 and 81a-81c includes a wafer element 862 and 82a-82c and a resilient element such as a spring 863 and 83a-83c. The lock unit 880 may also include one or more anti-tampering pins such as steel pins 855a and 855b.

According to some embodiments, the spring 831 of the key 800 is configured to exert a higher force than the force exerted by the spring 863 of the security mechanism wafer unit 860 so as to allow pushing one (e.g. bottom) side of the wafer element 861 inwardly in respect to an axis y, which is the rotation axis of the rotor 850, such as to align it with the other wafer elements 81a-81 also moved inwardly in respect to the axis y by the fitting key when inserted in the rotor 850 key slot 853. In this position of the wafer elements 861 and 81a-81c none of them protrudes from the outer walls of the rotor 850 and therefore the rotation of the rotor 850 in the stator 870 is enabled and not blocked.

In this example, as shown in FIG. 17C, the wafer units 860 and 81a-81c are all moved such that they are all confined between two planes upper level (UL) plane and lower level (LL) plane.

The springs 83a-83c of the locking mechanism wafer units 81a-81c are being compressed by the indented side(s) of the fitting key 800 when inserted into the slot 853 such as to have these wafer elements 82a-82c align within the boundaries of UL and LL.

It is clear from FIG. 17C that the lower cap element 823b of the telescopic member 830 of the fitting key 800 pushes the lower inner side of the wafer element 860 such as to move this element 861 downwardly to prevent its protrusion from the opening 856 in the rotor 850.

When there is no key inserted in the lock unit 880 or when a non-fitting key is inserted at least one of the wafer elements of 861 and 82a-82c will protrude from its opening and from the outer surface of the rotor 850 so as to interlock into a niche or a channel in the stator 870 for example thereby prevent the rotor 850 from rotating in the stator 870.

According to some embodiments, as shown in FIG. 17D, the rotor 850 is connected at a rear section thereof to a moveable element 885 ultimately connected to another one or more elements for performing the operation intended to be done by rotating of the rotor 850 in the stator 870 such as locking/unlocking, switching, opening or closing a valve and the like.

In case the lock set is used as a starter switching lock for example for a vehicle or any other engine based machine, the rotation of the rotor 850 in the stator 870 will rotate the moveable element 885 which may be configured and located such as to switch between modes of a switch such as on, off and other optional switchable modes defined in the system.

FIGS. 17D and 17E show how when the fitting key 800 is inserted through the slot 853 of the rotor 850 it moves the wafer elements 81a-81c and 860 such as to mechanically prevent any of them from protruding outwardly from the outer wall of the rotor 850 through their openings 852 and 856 for allowing the rotor 850 to freely rotate in the stator 870 i.e. for releasing the rotor 850.

FIG. 17E it shows how the wafer element 861 of the security mechanism pushed by the telescopic member 830 is prevented from protruding from the outer wall of the rotor 850 and into one of several recesses (e.g. channels) 853a-853d engraved in the inner wall of the stator 870.

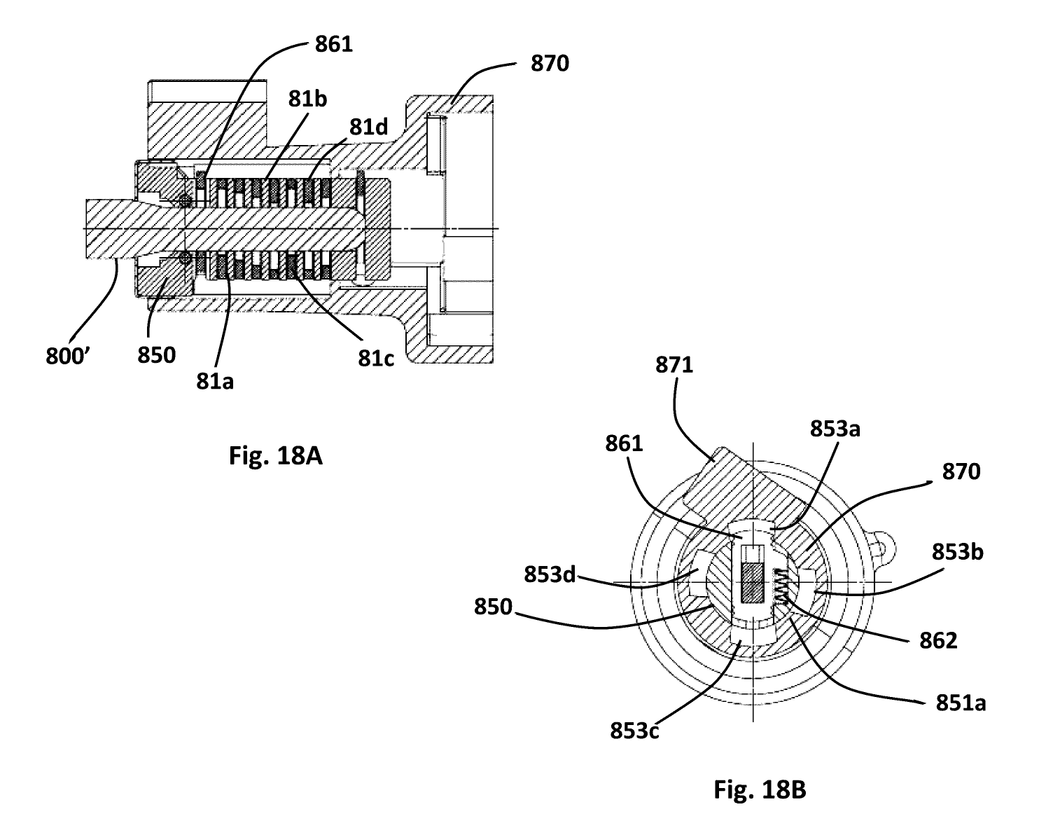

When no key is inserted or when an unfitting key is used such as an unfitting key 800′ shown in FIGS. 18A-18B that has the correct combination indentations but lacks a telescopic member, at least one of the wafer elements such as the wafer element 861 of the security mechanism will protrude outwardly from the outer wall of the rotor 850 and will be blocked by the channeled recess 853a preventing and blocking thereby the rotation of the rotor 850 in the stator 870.

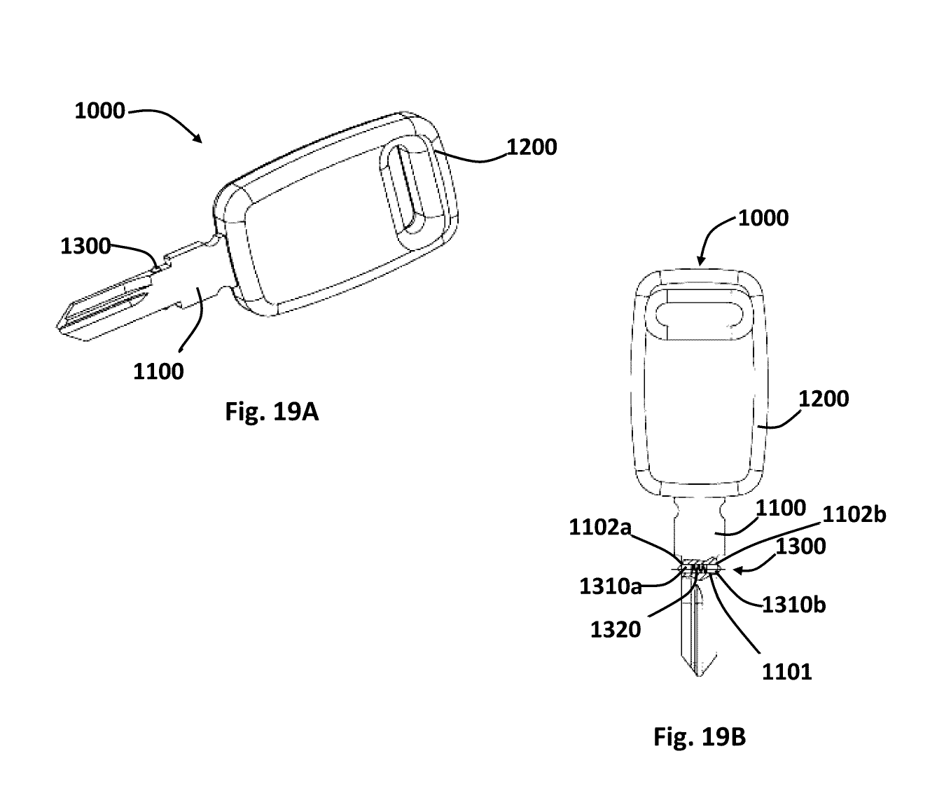

Reference is now made to FIGS. 19A-19B showing a blank key 1000 having a key shank 1100, a key head 1200 and one telescopic member 1300 located within a channel 1101 in the key shank 1100 located in proximity to the key head 1200 having two openings 1102a and 1102b located over sides of the key shank 1100 that are perpendicular to the sides of the shank 1100 designated for being indented for specifying the key blank 1000. Similarly to key blank 600, the telescopic member 1300 has two cap elements 1310a and 1310b connecting to two ends of a spring 1320 of the telescopic member 1300.

The key blank 1000 may fit to any type of lock unit and may be indented according to the specific type and design of the specific lock unit it is to fit.

The key head 1200 may be connectable to the key shank 1100 by any known in the art connection means. The key blank does not necessarily require having a key head.

The key blank 1000 may for example by used for specifying it to a lock unit having the wafer based security mechanism or to any other type of lock unit.

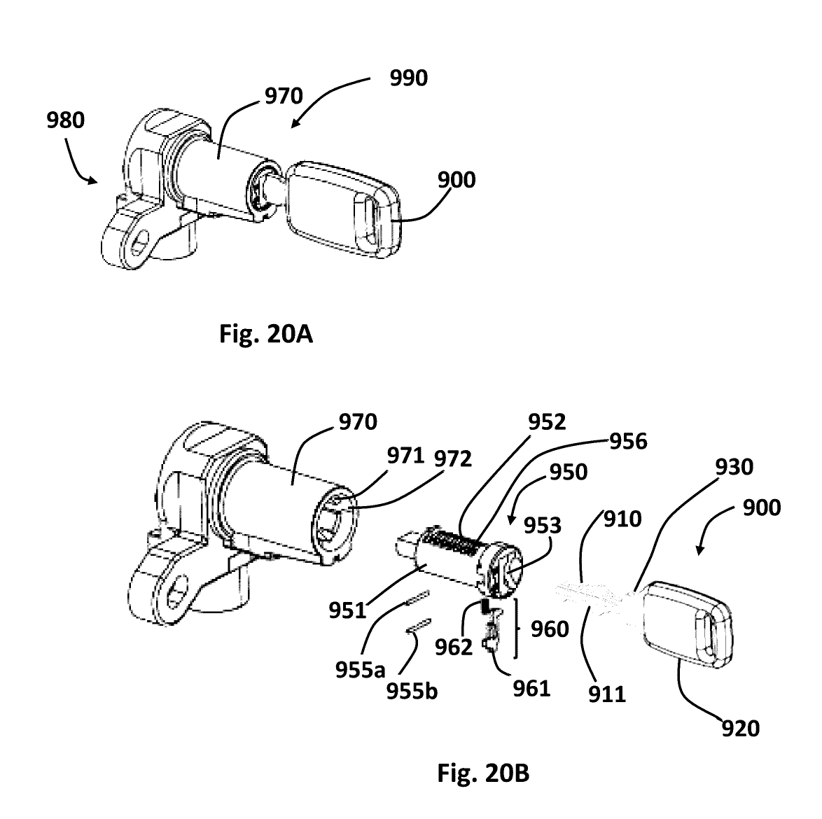

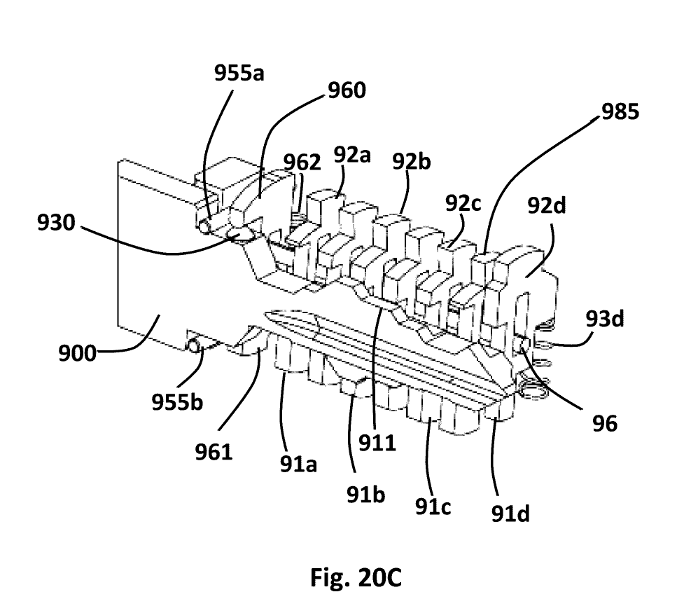

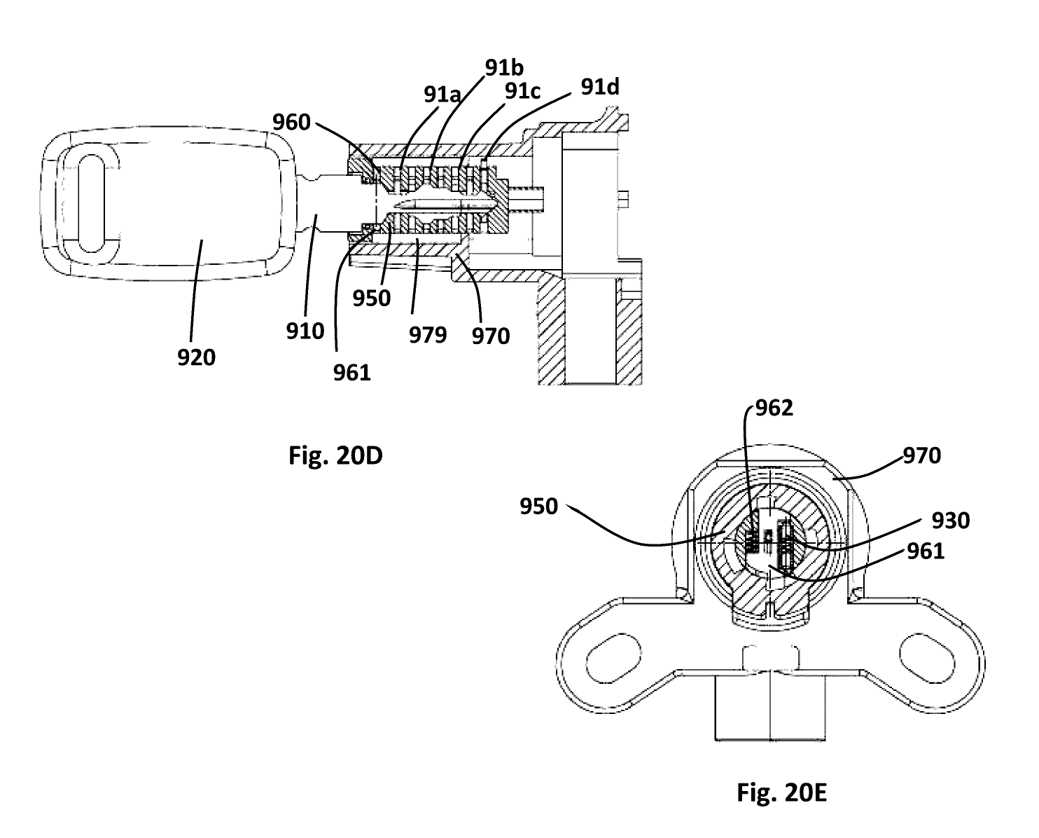

Reference is now made to FIGS. 20A-20 showing a lock set 990 for a locking system having a lock unit 980 and a fitting key 900, designed according to some embodiments of the invention. The lock unit 980 is a wafer tumbler lock that includes a rotor 950 and a stator 970, a first locking mechanism including a first set of wafer units 91a-91c held by a base structure 985, a security mechanism having a wafer unit 960 and other elements such as anti-tampering pins 955a and 955b and one or more moveable elements for ultimately enabling using the lock set 990 for the designated purpose thereof such as for locking or for switching. An elongated rod 96 may be used penetrated through the base structure 985 and openings in the wafer elements 92a-92d and 961 for securing thereof to the base structure 985. Each wafer unit 960 and 91a-91d includes a wafer element 961 and 92a-92d, respectively and a spring such as springs 962 and 93d.

The fitting key 900 of this lock set 990 includes a key shank 910 connected to a key head 920 and a telescopic member 930 inserted through a channel in the key shank 910.

Similarly to the description of the principles of the lock set 890, once the fitting key 900 is inserted through the key slot 953 the wafer elements 961 and 91a-91d are moved such as to prevent any of them from protruding from the outer wall of the rotor 950 for enabling free rotation of the rotor 950 in the stator 970.

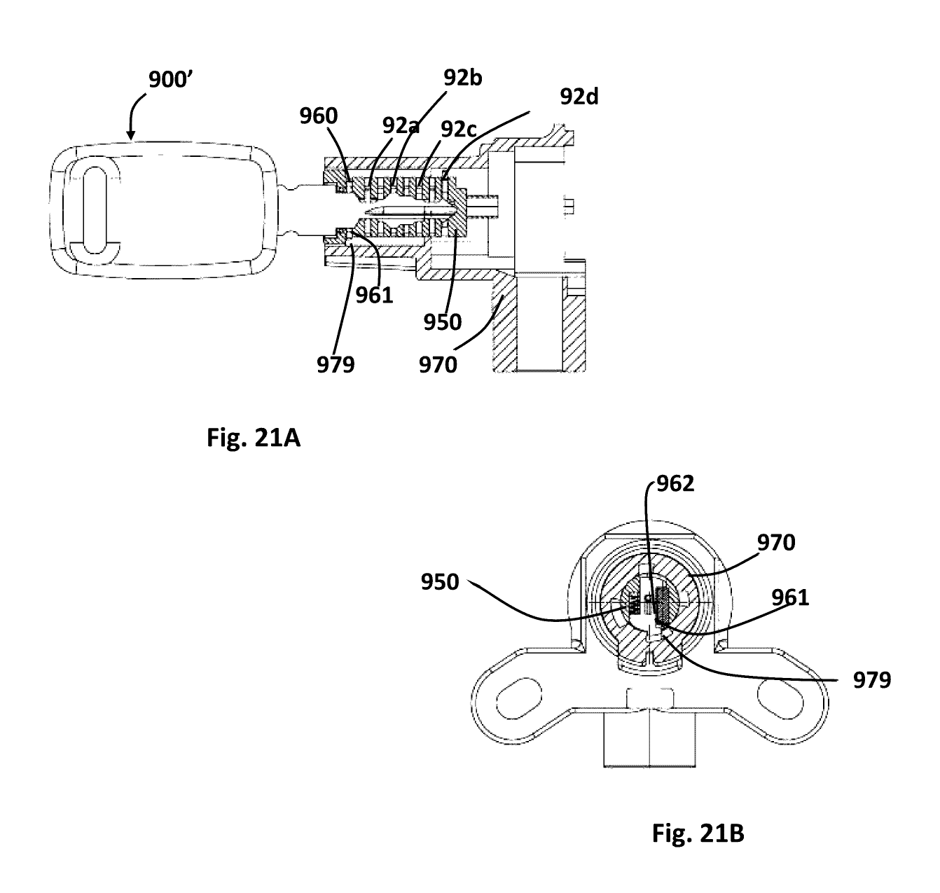

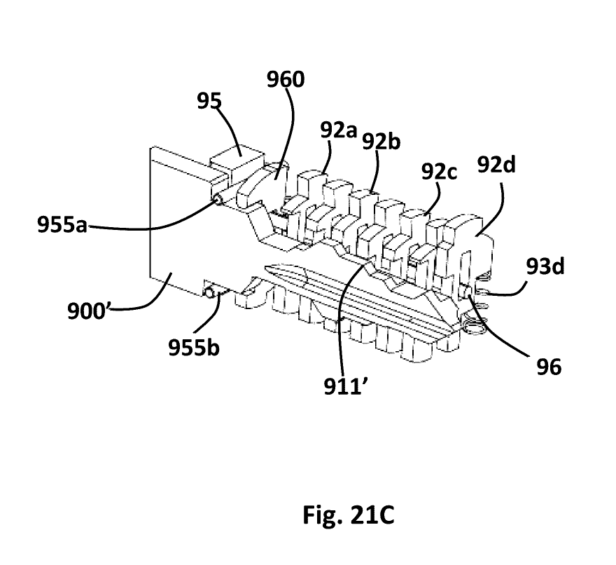

FIGS. 21A-21C show how when an unfitting key 900′ is inserted into the key slot 953, in this case a key having fitting indented combination but lacking the telescopic member, the wafer element 961 of the security mechanism will protrude from the outer wall of the rotor into a channel 979 grooved inside the stator 970 which will prevent the rotation for the rotor 950 in the stator 970.

Any other type and configuration of the locking mechanism can be used to implement the present invention, where the security mechanism added to the standard locking mechanism enhances security and safety.

The security mechanism of the present invention may include multiple wafer units requiring multiple telescopic members in the key shank of the fitting keys of the lock unit. The above figures illustrated using a single telescopic element located in a channel perforated through one side of the key shank however any location and orientation of the channel and the telescopic member(s) therein can be implemented.

The lock units of the present invention may also include other known in the art elements, mechanisms and/or means for performing the lock operational purposes such as fixation means for fixating the stator in the system, apparatus, object or device, other moveable elements, starter circuitry, switching means and the like. The key head may also be equipped with other devices, as known in the art such as in devices for automatic locking and unlocking of a vehicle, alarm related devices etc.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A key blank comprising:
a) a key shank having at least one channel perforated over at least one side thereof, said key shank is configured for connecting at one first end thereof to a key head; and
b) at least one telescopic member each inserted in each of said at least one channel in said key shank, each of said at least one telescopic member comprising at least one resilient element and two cap elements each cap element being located at an edge of said telescopic member,
wherein said telescopic member is configured such that it is changeable in length in response to a force applied thereover and returnable to a predefined relaxation state length, and
wherein said at least one telescopic member is located and configured such as to engage at least one corresponding wafer of a wafer tumbler lock unit for moving said corresponding wafer to allow rotation of a rotor inside a stator of the respective wafer tumbler lock unit.

2. The key blank according to claim 1, wherein said at least one resilient element is a spring.

3. The key blank according to claim 1, wherein each of said at least one telescopic member and channel thereof is located proximally to said first end of said key shank and before an area over said key shank that is to be indented for specifying of the blank key, and wherein each channel is located such that at least one of said cap elements of said telescopic member located therein is protrudable from at least one side of said key shank that is perpendicular to the at least one side of the key shank that is to be indented.

4. A key blank comprising:
a) a key shank having at least one channel perforated over at least one side thereof, said key shank is configured for connecting at a first end thereof to a key head; and
b) at least one telescopic member each inserted in each of said at least one channel in said key shank, each of said at least one telescopic member comprising at least one resilient element and two cap elements each cap element being located at an edge of said telescopic member,
wherein said telescopic member is configured such that it is changeable in length in response to a force applied thereover and returnable to a predefined relaxation state length,
wherein each of said at least one telescopic member and channel thereof is located over said key shank proximally to said first end thereof and before an area over said key shank that is to be indented for specifying of the blank key, and
wherein each channel is located such that at least one of said cap elements of said telescopic member located therein is protrudable from at least one side of said key shank that is perpendicular to the at least one side of the key shank that is to be indented.

5. The key blank according to claim 4, wherein said at least one resilient element is a spring.

6. The key blank according to claim 4, wherein said at least one telescopic member is located and configured such as to engage at least one corresponding wafer of a wafer tumbler lock unit.

7. A lock set comprising:
a) a cylinder lock comprising:
a stator;
a rotor configured for being coaxially situated in said stator for rotating therein, said rotor having at least one key slot for receiving a key therein and at least one wafer opening;
a first locking mechanism; and
an additional security mechanism comprising at least one wafer unit inserted through at least one of said at least one wafer opening in said rotor;
and
b) at least one fitting key having a key shank with at least one combination indented or etched over at least one side thereof and at least one telescopic member each inserted in a channel perforated in the key shank of said fitting key, said telescopic member being configured such that it can change at least in length in response to a force applied thereover and return to a predefined relaxation state length,
wherein said wafer unit of said additional security mechanism is located and configured for engaging at least one edge of said telescopic member of said fitting key when inserted through the key slot such that each of said at least one telescopic member will move the respective wafer unit it engages such that the fitting key will enable to release the additional security mechanism and the first locking mechanism for positioning the rotor in a released rotor position, in which said rotor is freely rotatable in said stator.

8. The lock set according to claim 7, wherein said lock unit is a wafer tumbler lock unit and said first locking mechanism comprises at least one other wafer unit configured to fit the indentation combination of the fitting key, each other wafer unit being inserted through a wafer opening in said rotor.

9. The lock set according to claim 8, wherein said wafer tumbler lock unit further comprises a base structure holding all wafer units of said first locking mechanism and said additional security mechanism partially also configured to engage the fitting key indentation combination.

10. The lock set according to claim 8, wherein each said wafer unit comprises a wafer element and at least one resilient element.

11. The lock set according to claim 10, wherein said at least one telescopic member comprises a resilient element and two cap elements each cap element being connected to a different edge of said resilient element.

12. The lock set according to claim 11, wherein the resilient element of each of said at least one telescopic member exerts a force that is greater than the force exerted by the resilient element of the second wafer unit such as to force the wafer element thereof to move for releasing the rotor, when the fitting key is inserted in the cylinder lock unit.

13. The lock set according to claim 12, wherein said resilient element is a coiled spring.

14. The lock set according to claim 7, wherein said at least one telescopic member of the fitting key and channel in which it is located are located proximally to the key head and before the area over the shank of the fitting key that indented.

15. The lock set according to claim 7, wherein said telescopic member protrudes in a relaxed state thereof at least from one side of the key shank from a respective opening of the channel in which it is located, said protrusion opening from which it protrudes is perpendicular to the at least one side of the key shank over which the combination is indented.

16. The lock set according to claim 7 further comprising at least one moveable element operatively associated with said rotor such that once the rotor is rotated in said stator it moves said at least one moveable element for operating said lock unit.
